(19) United States
(12) Patent Application Publication
(10) Pub. No.: US 2022/0183792 A1
(43) Pub. Date: Jun. 16, 2022

(54) DENTAL ALIGNERS AND PROCEDURES FOR ALIGNING TEETH

(71) Applicant: Candid Care Co., New York, NY (US)

(72) Inventor: CHESTER LYNN HURST, New York, NY (US)

(73) Assignee: Candid Care Co., New York, NY (US)

(21) Appl. No.: 17/602,496

(22) PCT Filed: Apr. 10, 2020
(86) PCT No.: PCT/US20/27633

§ 371 Date: Oct. 8, 2021

Related U.S. Application Data
(60) Provisional application No. 62/832,550, filed on Apr. 11, 2019.

(51) Int. Cl. A61C 7/00; A61C 7/08

(52) U.S. Cl. CPC A61C 7/002; A61C 7/08

(57) ABSTRACT

A method, system, and apparatus for orthodontic treatment planning to align a patient's teeth, and dental appliance devices for aligning the patient's teeth based on the method. The method comprises performing pre-staging to evaluate a patient's general oral and periodontal health. Additionally, the method comprises performing a lower arch stage of treatment planning to define movement of at least one tooth of a lower arch, performing an upper arch stage of treatment planning to define movement of at least one tooth of an upper arch, and performing a final arch stage of treatment planning to define articulation of the lower and upper arches. Dental appliances can be fabricated that have geometries determined based on at least one of the lower arch stage, upper arch stage, and final arch stage. Patient wear of successive dental appliances manipulates the patient's teeth to a final, aligned teeth arrangement, as planned by the method.

### CROSS REFERENCE TO RELATED APPLICATION

This application claims the benefit of priority of U.S. Provisional Application No. 62/832,550, filed Apr. 11, 2019, which is hereby incorporated by reference as if set forth fully herein.

### BACKGROUND

Traditionally, metal braces, temporary anchorage devices (TADs), Class II connectors, headgear, elastics, wires and the like were used to reposition a patient's teeth over time, in order to provide better teeth alignment. Metal braces, for example, include brackets that affix to a patient's teeth. Wires are threaded through slots in the brackets and are maintained in connection with the brackets by way of rubber bands. Typically, the brackets include stainless steel. The wires apply a constant force that causes movement and alignment of the patient's teeth.

However, the use of metal braces and other mechanisms mentioned above to reposition teeth is uncomfortable and oftentimes painful to the patient, unsightly, and requires time consuming and costly patient visits to a treating orthodontist. Moreover, in such traditional methods, the treating orthodontist prescribes a desired tooth arrangement, but without precise calculations of factors such as tooth forces, avoidance of tooth collisions, and the like. As a result, traditional tooth alignment efforts often lack sufficient precision to enable efficient tooth alignment.

Clear dental aligners are orthodontic appliance devices that are used to adjust teeth. When worn for a particular amount of time (e.g., 22 hours per day over two weeks), a dental aligner slowly moves a patient's teeth to positions that were prescribed by an orthodontist or dentist. Dental aligners are typically manufactured based on the assessment of diagnostic records, such as intra oral and extra oral photographs, study models (virtual or otherwise), panoramic radiographs (x-rays), and generally are formed of transparent plastic.

U.S. Pat. No. 8,070,487 B2 is directed to a method and apparatus for fitting a set of upper teeth to lower teeth in a masticatory system by generating a computer representation of the system and computing an occlusion based on interactions in the computer representation of the system.

European Patent 1876990B1 describes methods of moving a subject's teeth wherein one or more aligners are provided to a subject to wear, so that the aligners may exert force to move the subject's teeth. The aligners can be designed as part of a series of aligners to be worn, and the series may be determined based on the subject's initial teeth position, and based on input from a user (e.g., an orthodontist).

### SUMMARY

A method, apparatus, system, and computer-readable medium, for orthodontic treatment planning. According to one example embodiment herein, the method comprises performing a lower arch stage of treatment planning to define movement of at least one tooth of a lower arch, performing an upper arch stage of treatment planning to define movement of at least one tooth of an upper arch, and performing a final arch stage of treatment planning to define articulation of the lower and upper arches. A next step includes providing dental appliances having geometries determined based on at least one of the performed lower arch stage of treatment planning, the upper arch stage of treatment planning, and the final arch stage of treatment planning.

In one example embodiment herein, the method further comprises performing pre-staging to evaluate a patient's general oral and periodontal health.

The upper arch stage of treatment planning, the lower arch stage of treatment planning, and the final arch stage of treatment planning, are performed to align teeth of the upper and lower arches, according to one example embodiment herein.

In an additional example embodiment herein, the upper and lower arches are included in a computer model. Also in one example embodiment herein, the geometries of the dental appliances differ from one another.

The dental appliances are wearable by a patient, and successive wears by the patient of respective ones of the dental appliances manipulate teeth of the patient to a final teeth arrangement.

Also in one example embodiment herein, the movements avoid tooth collisions. In an additional example embodiment herein, at least one of the upper arch stage of treatment planning or the lower arch stage of treatment planning includes a distalization to correct a malocclusion.

Also, in one example embodiment herein, at least one of the performings is performed using an electronic user interface that depicts the upper and lower arches in the computer model.

Also in an example embodiment herein, tooth movement includes one or more of displacing, rotating, aligning, a translation, distalization, expansion, proclination, lingualization, mesialization, tipping, torqueing, intrusion, and extrusion of at least one tooth. Also in an example embodiment herein, at least one tooth movement is in accordance with at least one of a prescribed curve of Spee or a prescribed curve of Wilson. In a further example embodiment herein, the final arch stage of treatment planning includes one or more of performing a change in crown torque on at least one tooth, performing aesthetic positioning of at least one tooth, and substantially avoiding interproximal reduction.

In accordance with a further example aspect herein, a system is provided for positioning a patient's teeth. The system comprises a plurality of dental appliances. Each appliance has respective geometries determined based on at least one of a lower arch stage of treatment planning, an upper arch stage of treatment planning, or a final arch stage of treatment planning. The lower arch stage of treatment planning defines movement of at least one tooth of a lower arch, the upper arch stage of treatment planning defines movement of at least one tooth of an upper arch, and the final arch stage of treatment planning defines articulation of the lower and upper arches. The dental appliances are wearable on teeth of a patient, and successive wears on the teeth of the patient of respective ones of the dental appliances manipulate the teeth of the patient to a final teeth arrangement. In one example embodiment herein, the dental appliances manipulate the teeth of the patient without causing tooth collisions, and, in the final teeth arrangement, the teeth of the patient are substantially aligned.

### BRIEF DESCRIPTION OF THE DRAWINGS

FIG. 1 illustrates a method according to an example aspect herein.

FIG. 2 illustrates a method of performing lower arch pre-staging, according to a step of the method of FIG. 1.

FIG. 3 illustrates a method of performing upper arch pre-staging, according to a step of the method of FIG. 1.

FIG. 4 is a diagram of a data processing system 400 according to an example embodiment herein.

FIG. 5 shows a 3D model of a patient's lower teeth.

FIG. 6 illustrates a dental aligner constructed according to an example aspect herein.

FIG. 7 represents lingualization of teeth of an arch, according to an example embodiment herein.

FIG. 8 represents proclination of teeth of an arch, according to an example embodiment herein.

FIG. 9 represents expansion of an arch, according to an example embodiment herein.

FIG. 10 represents mesialization of an arch, according to an example embodiment herein.

FIG. 11 represents distalization of an arch, according to an example embodiment herein.

FIG. 12 represents translation of a tooth, according to an example embodiment herein.

FIG. 13 represents rotation of a tooth, according to an example embodiment herein.

FIG. 14 represents extrusion of a tooth, according to an example embodiment herein.

FIG. 15 represents intrusion of a tooth, according to an example embodiment herein.

FIG. 16 represents torqueing of a tooth, according to an example embodiment herein.

FIG. 17 represents root tipping of a tooth, according to an example embodiment herein.

FIG. 18 represents crown tipping of a tooth, according to an example embodiment herein.

FIG. 19 depicts an interface that includes a front view of a model of upper and lower arches of a patient, and controls for viewing the model, in a starting step of a treatment plan for aligning teeth.

FIG. 20 depicts an interface that includes a left side view of the model of upper and lower arches of the patient, and controls for viewing the model, in the starting step of a treatment plan for aligning teeth.

FIG. 21 depicts an interface that includes a right side view of the model of upper and lower arches of the patient, and controls for viewing the model, in the starting step of the treatment plan for aligning teeth.

FIG. 22 depicts an interface that includes the lower arch of the model, and controls for viewing the model, in the starting step of the treatment plan for aligning teeth.

FIG. 23 depicts an interface that includes the upper arch of the model, and controls for viewing the model, in the starting step of the treatment plan for aligning teeth.

FIG. 24 depicts an interface that includes a front view of the model of upper and lower arches of the patient, and controls for viewing the model, in a further step of the treatment plan for aligning teeth.

FIG. 25 depicts an interface that includes a left side view of the model of upper and lower arches of the patient, and controls for viewing the model, in the further step of the treatment plan for aligning teeth.

FIG. 26 depicts an interface that includes a right side view of the model of upper and lower arches of the patient, and controls for viewing the model, in the further step of the treatment plan for aligning teeth.

FIG. 27 depicts an interface that includes the lower arch of the model, and controls for viewing the model, in the further step of the treatment plan for aligning teeth.

FIG. 28 depicts an interface that includes the upper arch of the model, and controls for viewing the model, in the further step of the treatment plan for aligning teeth.

FIG. 29 depicts an interface that includes a front view of the model of upper and lower arches of the patient, and controls for viewing the model, in an additional step of the treatment plan for aligning teeth.

FIG. 30 depicts an interface that includes a left side view of the model of upper and lower arches of the patient, and controls for viewing the model, in the additional step of the treatment plan for aligning teeth.

FIG. 31 depicts an interface that includes a right side view of the model of upper and lower arches of the patient, and controls for viewing the model, in the additional step of the treatment plan for aligning teeth.

FIG. 32 depicts an interface that includes the lower arch of the model, and controls for viewing the model, in the additional step of the treatment plan for aligning teeth.

FIG. 33 depicts an interface that includes the upper arch of the model, and controls for viewing the model, in the additional step of the treatment plan for aligning teeth.

FIG. 34 depicts an interface that includes a front view of the model of upper and lower arches of the patient, and controls for viewing the model, in another step of the treatment plan for aligning teeth.

FIG. 35 depicts an interface that includes a left side view of the model of upper and lower arches of the patient, and controls for viewing the model, in the other step of the treatment plan for aligning teeth.

FIG. 36 depicts an interface that includes a right side view of the model of upper and lower arches of the patient, and controls for viewing the model, in the other step of the treatment plan for aligning teeth.

FIG. 37 depicts an interface that includes the lower arch of the model, and controls for viewing the model, in the other step of the treatment plan for aligning teeth.

FIG. 38 depicts an interface that includes the upper arch of the model, and controls for viewing the model, in the other step of the treatment plan for aligning teeth.

Same reference numerals appearing in different ones of the figures represent the same components, although each component may not be described in detail herein with respect to the description of each separate figure.

### DETAILED DESCRIPTION

The inventor has developed novel and inventive methods and devices for repositioning and/or aligning a patient's teeth, to ensure greater accuracy, quality, and predictability in tooth alignments, while avoiding limitations associated with the use of traditional metal braces, wires, and the like for repositioning teeth. In one example embodiment herein, the method includes performing pre-staging, lower arch staging, upper arch staging, and final staging, and also can include manufacturing one or a series of dental appliances (e.g., such as dental aligners) based on at least one of the stagings. In one example embodiment herein, the pre-staging is performed to evaluate a patient's general oral and periodontal health, and the lower arch staging involves treatment planning to define movement of at least one tooth of a lower arch. Also in one example embodiment herein, the upper arch staging involves treatment planning to define movement of at least one tooth of an upper arch, and the final arch stage involves treatment planning to define articulation of the lower and upper arches. The upper arch stage, lower arch stage, and final arch stage (which, in one example embodiment, can be performed using a computer model) are performed to place the teeth in a final arrangement in which preferably the teeth of the upper and lower arches are aligned.

The dental appliances can be manufactured to have geometries determined based on at least one of the performed lower arch stage, upper arch stage, and final arch stage. The dental aligner(s) have geometries determined by the stagings to enable a patient's teeth to be repositioned/re-orientated as planned by the stagings, from an initial teeth arrangement, until the teeth have a final (prescribed aligned) arrangement. The aligners can be worn by the patient in order to reposition/re-orientate the patient's teeth, without requiring the use of metal braces, TADs, Class II connectors, headgear, elastics, wires and the like. Also, while conventionally it was challenging, if not impossible, to perform anterior-posterior/sagittal correction by anterior movement of the mandible, without using mechanisms such as headgear, elastics, TAD's or Class II correctors, the method(s) and aligners described herein enable such corrections to be performed without necessarily requiring the conventional mechanisms.

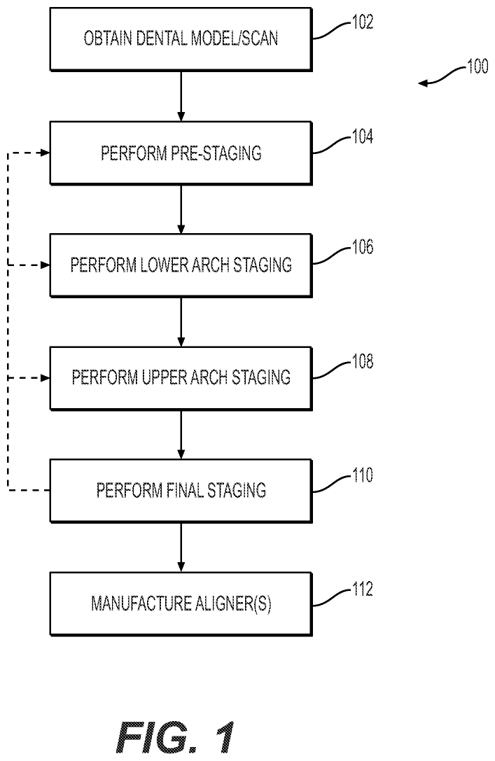

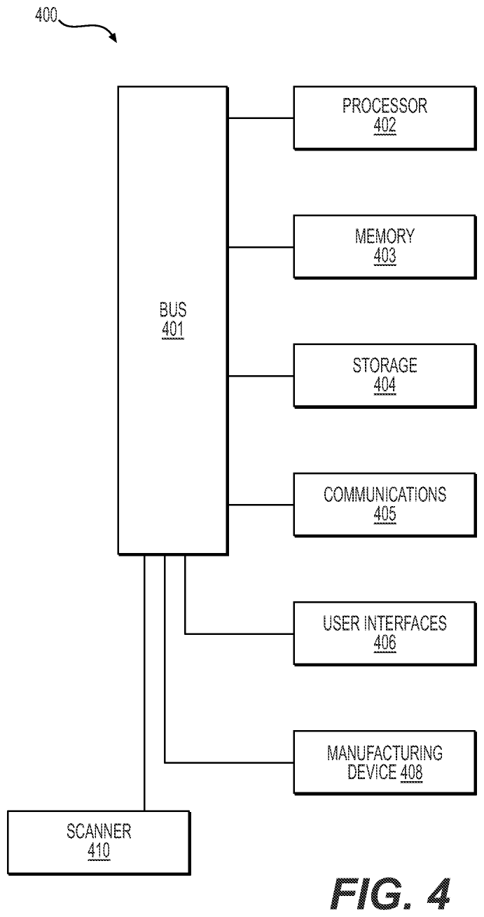

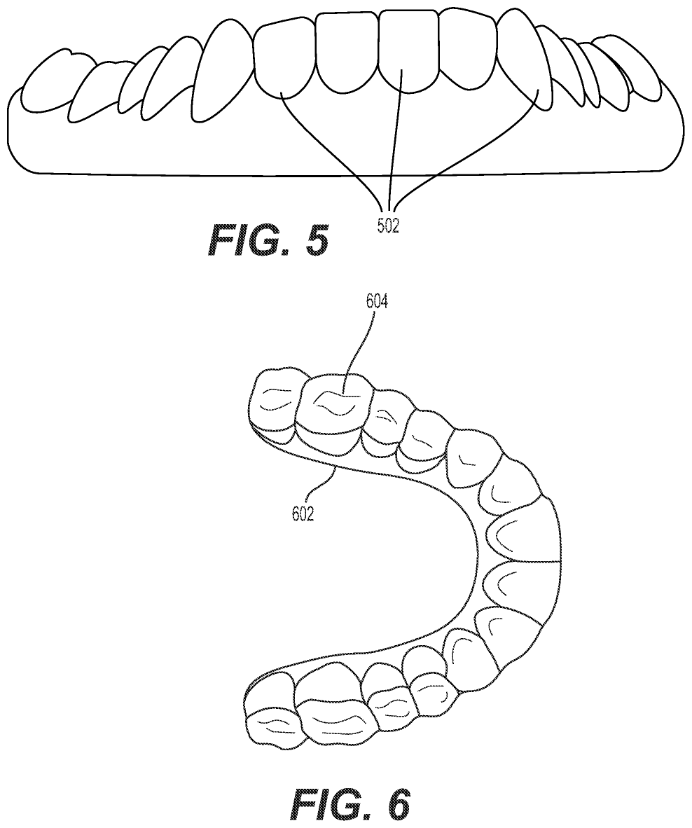

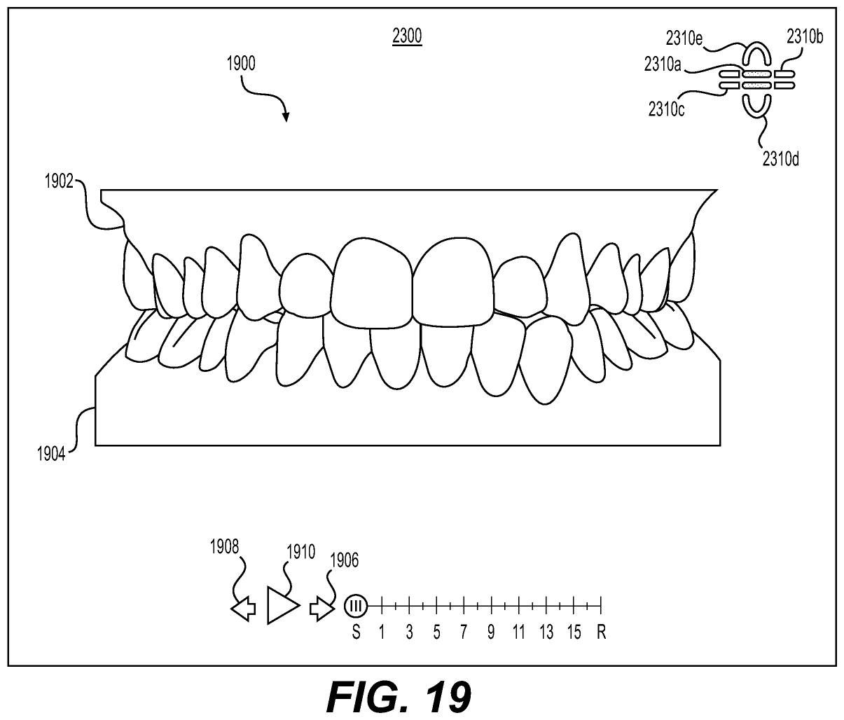

A method 100 according to an example aspect herein will now be described, with reference to FIG. 1. In step 102 a dental impression of a patient's dental arch is obtained. A dental impression is a negative imprint of hard (teeth) and soft tissues in a patient's mouth. Also in step 102, a positive reproduction (i.e., a cast or model) is then formed of the dental arch, including a reproduction of the teeth and soft tissue. Additionally in step 102, 3D scans are then taken (by, for example, scanner 410 of FIG. 4 to be described below) of the reproduction to provide digital data (also referred to herein as “scans” or “3D scans”) representing the reproduction. The 3D scans, which in one example can be included in one or more stereolithography (STL) files, can form a 3D computer model of the upper and lower arches of the patient, and the model can be viewed and manipulated by a user in virtual 3D space via a user interface (such as user-interface 406, e.g., a display, and/or 2300 to be described below). FIG. 5 shows an example of a displayed 3D model of a patient's lower arch. (FIG. 19 represents an example interface 2300 that shows a computer model 1900 (e.g., 2D or 3D) of an upper and lower arch at a starting step S of a treatment procedure, as will be described below). In another example embodiment, the positive reproduction need not be formed (in step 102), and instead (using, e.g., scanner 410) a direct digital impression of the patient's arch can be obtained in step 102, or the physical dental impression is digitized for being employed in the steps below.

Pre-staging is then performed, in step 104. In one example embodiment herein, pre-staging 104 includes an orthodontist or specialist reviewing diagnostic records, such as, by example and without limitation, individual scans or a collage of scans, upper/lower arch STL files, 3D scans, 3D models (e.g., such as those described above), the patient's medical/dental history, the absence/presence of third molars or other teeth, the patient's general oral health and periodontal health, extra-oral photography and the like. Pre-staging can be performed with an eye towards determining which upper/lower tooth movements are possible or desired to be effected for the patient, in order to provide the patient with an optimal tooth alignment in terms of function and/or aesthetics.

After step 104, lower arch staging 106 is performed. In one example embodiment herein, lower arch staging 106 preferably is performed prior to upper arch staging 108 (to be described below), and the lower arch staging 106 involves treatment planning to define movement of at least one tooth of a lower arch, for purposes of overall teeth alignment. For a patient's lower arch, there is less bone than in the upper arch, and the medullary bone is in a trough bordered buccal/lingually by a cortical bone, resulting in limited tooth movement options relative to upper arch teeth. Performing lower arch staging 106 before upper arch staging 108 helps to establish the lower arch/teeth first, thereby enabling a best fit to be achieved of the upper teeth to the lower teeth when steps 108 and 110 are later performed.

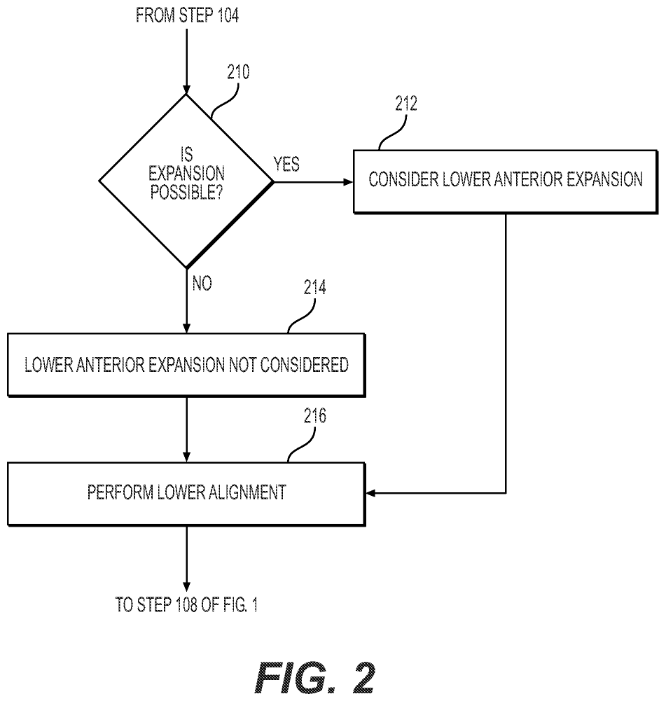

FIG. 2 shows in greater detail an example of how lower arch pre-staging according to step 106 is performed, according to one example embodiment herein. In step 210 a determination is made as to whether lower anterior/buccal expansion is possible. By example only, this determination can be based on an evaluation of the periodontal health (e.g., the presence of plaque, calculus, inflammation/recession or the like) of the patient's lower teeth/arch, and, in one example embodiment, is performed based on information evaluated/obtained in step 104. If it is determined that the patient's lower teeth/arch are/is healthy (“Yes” in step 210), then lower expansion or repositioning of the lower teeth can be considered (step 212), and the procedure proceeds to step 216, which will be described below. On the other, if it is determined that the patient's lower teeth/arch are/is not healthy (“No” in step 210), then lower anterior expansion should not be considered, and other procedures can be considered such as, by example and without limitation, buccal expansion and/or sequential step distalization, or it can be decided to not treat the lower teeth/arch (step 214).

Step 216 is performed after either of steps 212 and 214 is performed. In step 216, the user can operate an input user interface (such as interface 406 and/or 2300 to be described below) to manipulate the 3D model and one or more of the lower teeth 500 (FIG. 5) and to perform various procedures in an effort to plan to manipulate, and/or manipulate, the positions and orientations of one or more lower teeth 502 of the model, such that, after all steps 106 to 108 of FIG. 1 are performed, the upper and lower teeth will be optimally aligned (and placed in a prescribed final arrangement) with regard to function and aesthetics. Step 216 can include various considerations (e.g., based on information obtained in step 104), functions and procedures. By example only and without limitation, step 216 can include one or more of moving (e.g., displacing) and/or rotating one or more lower teeth (e.g., starting with a molar, in one example), aligning one or more lower teeth, translation, distalization, expansion (where deemed appropriate, such as in a case of “Yes” in step 210), proclination, lingualization, and/or mesialization of one or more lower teeth, and the like, to establish a symmetrical form and dental midline in the 3D model. Step 216 also can include considering and/or performing tipping, torque (torqueing), intrusion, and/or extrusion to achieve those goals.

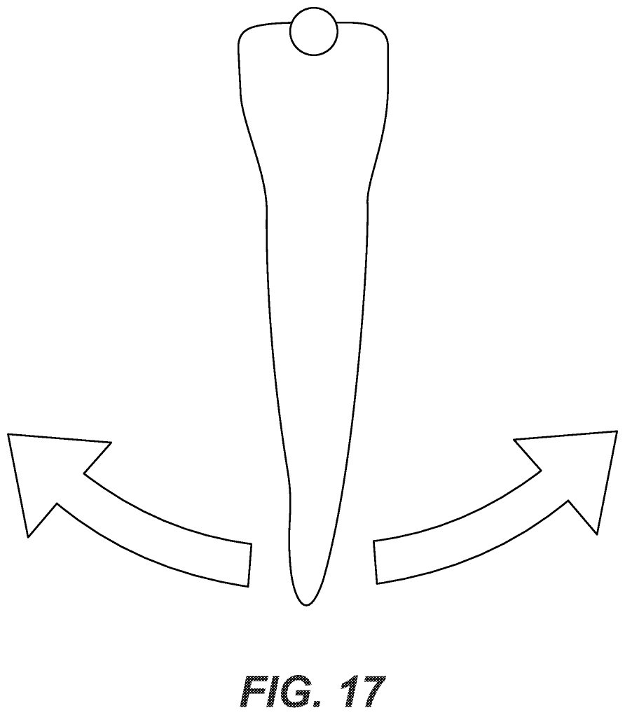

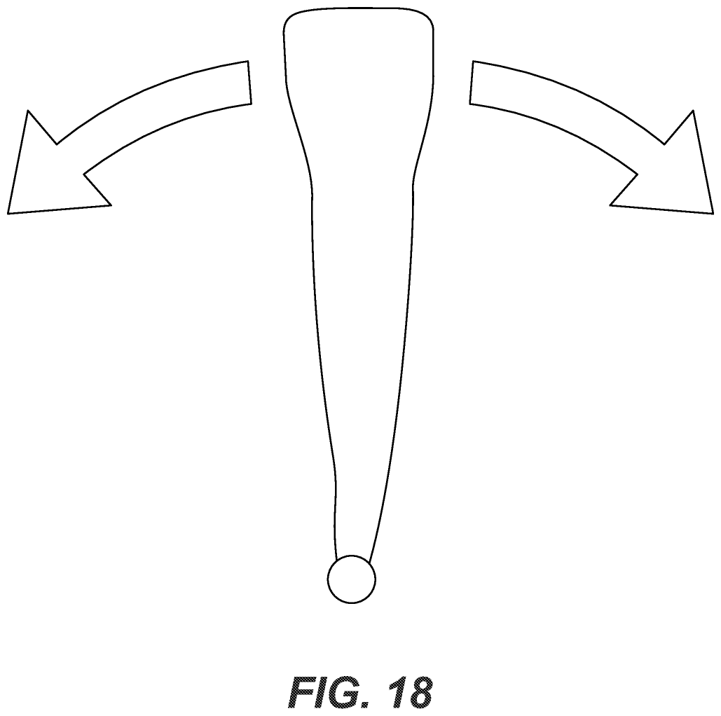

Tipping can include, by example and referring to FIG. 18, crown tipping, which is the tilting of the crown of a tooth without moving the apex of the root. Tipping also can include, by example, root tipping. Root tipping, an example of which is represented in FIG. 17, involves tilting of a root of a tooth without moving the apex of the crown. Torqueing has evolved from fixed appliances and, although there is no wire and bracket, the concept can be applied to clear aligners. In clear aligner therapy, and referring for example to FIG. 16, to torque a tooth is to move the tooth buccolingually around the centerpoint, so the crown and root move in opposite directions. It is the twisting force which is traditionally required to adjust the inclination of a crown.

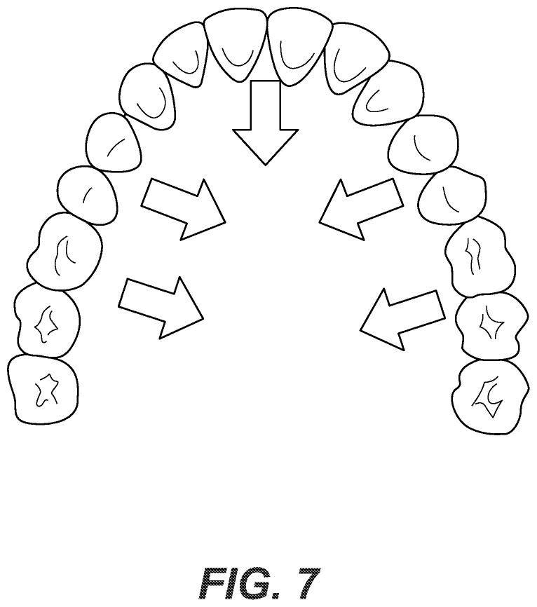

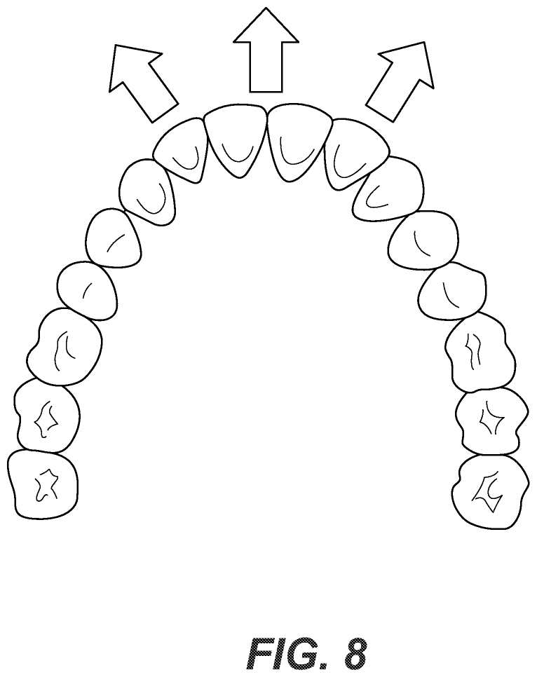

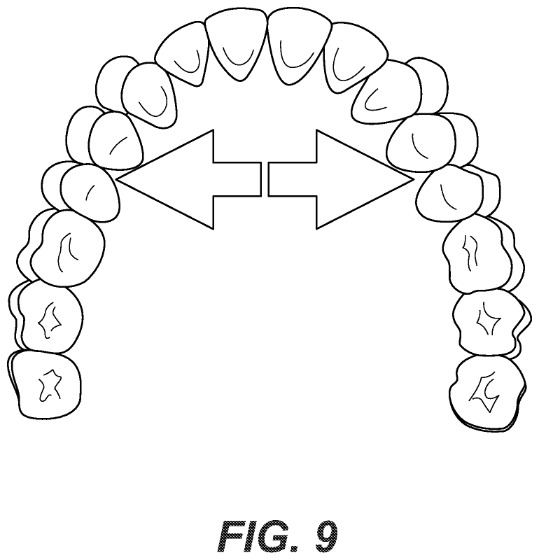

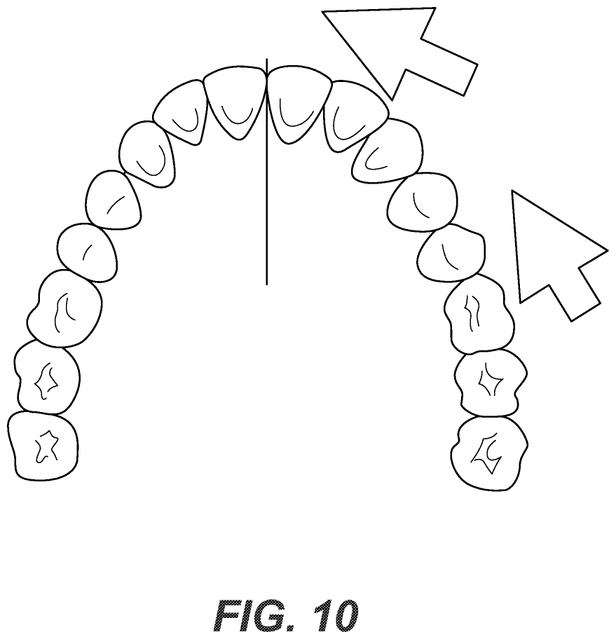

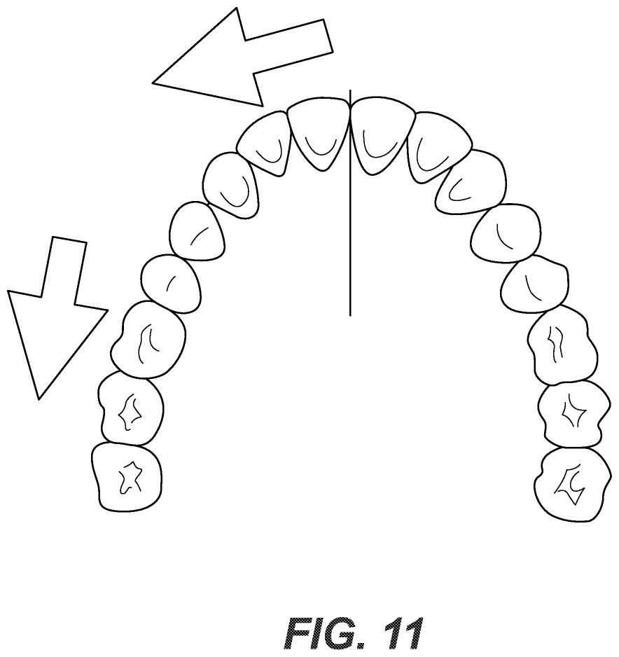

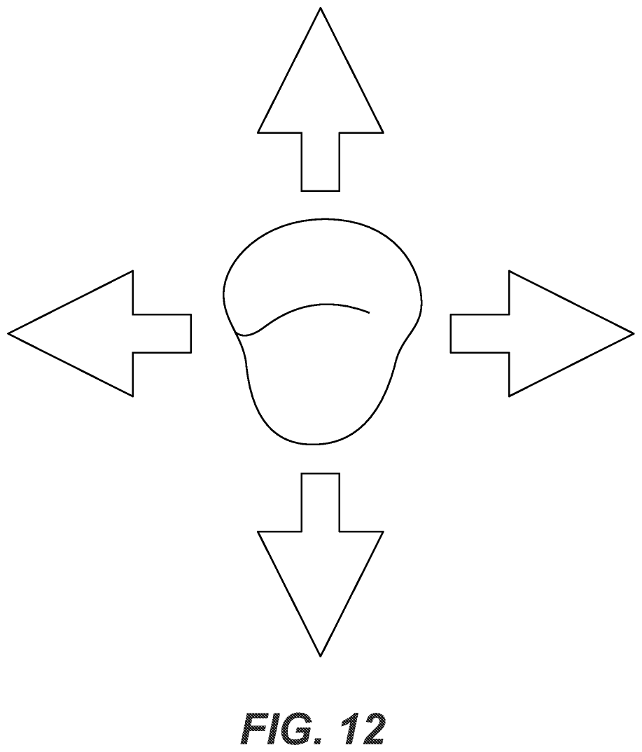

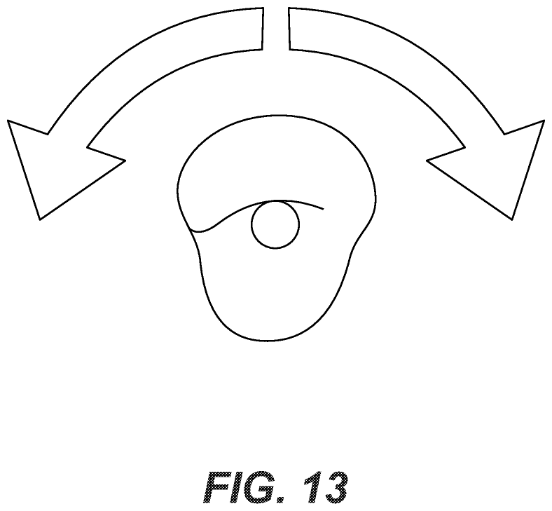

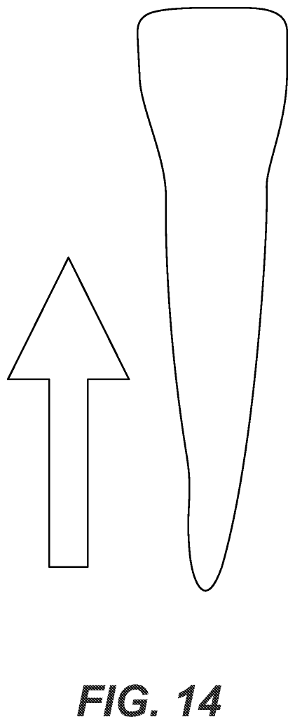

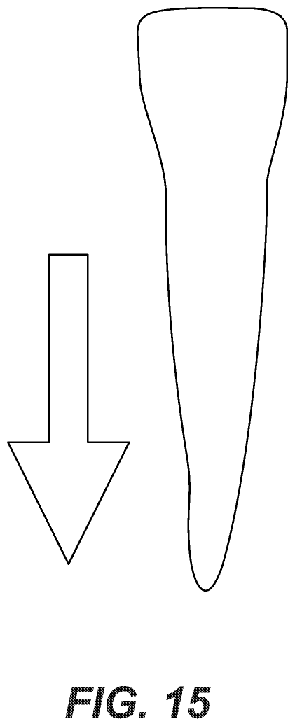

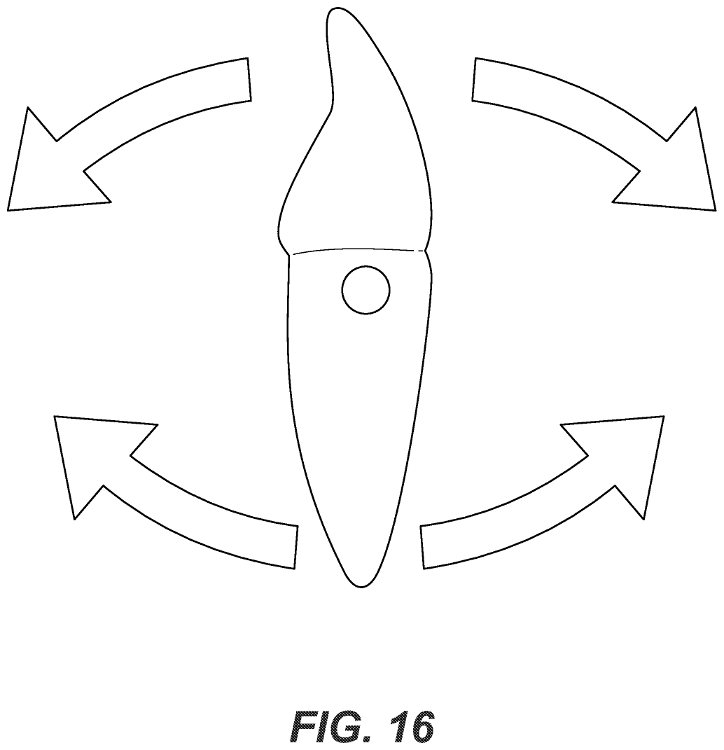

Referring to FIG. 15, intrusion can involve moving a tooth into supporting structures, and extrusion is moving of a tooth out of a supporting structure (FIG. 14). Rotation can include, by example and referring to FIG. 13, turning of a tooth about its long axis. Translation can include, for example and referring to FIG. 12, shifting a tooth along an occlusal plane without changing an orientation of the long axis. Distalization can include, by example and referring to FIG. 11, moving a tooth along the occlusal plane away from the midline. Mesialization can include, by example and referring to FIG. 10, moving a tooth along the occlusal plane towards the midline. Expansion includes, by example and referring to FIG. 9, moving posterior teeth outwards away from the midline. Proclination includes, by example and referring to FIG. 8, tipping the crown of anterior teeth labially. Lingualization can include, by example and referring to FIG. 7, moving teeth towards the tongue side of the arch. Step 214 and/or 216 also can include considering factors such as the curve of Spee, and/or the curve of Wilson of the patient, in manipulating and/or determining how one or more teeth should be manipulated as described above (in step 216). Also, step 216 can include performing Class III anterior-posterior/sagittal corrections, which in one example can be addressed in the lower arch with sequential step distalization. Step 216 also can include, in determining how one or more lower teeth should be manipulated as described above, determining a maximum displacement of the one or more teeth in the lower arch, determining an amount of force that should be applied to one or more teeth in order to move the teeth, determining an amount and/or angle of displacement and/or a travel path of one or more teeth, determining a length of time that the patient should wear an aligner to effect the movement, performing lower anterior expansion (in the case of “Yes” in step 210), determining which teeth should be anchors and which ones to move, performing buccal expansion and/or sequential step distalization, or deciding not to treat (in the case of “No” in step 210), and/or the like. In one example embodiment herein, step 216 also is performed such that mesio-distal contact collisions are avoided or substantially minimized. Each of the foregoing can be based, in one example embodiment, upon results obtained in pre-staging step 104.

An assessment (e.g., an automatic assessment or by an orthodontist/technician) of result(s) of step 216 can then be performed. According to an example aspect herein, steps 214 and 216 are performed without using or considering using attachments, interproximal reduction (IPR), buttons, elastics, metal braces, wires, and the like, and, in one example embodiment, the steps are performed to avoid or substantially minimize mesio-distal contact collisions.

After step 216 is performed, upper arch staging is performed in step 108 (FIG. 1). Upper arch staging 108 involves treatment planning to define movement of at least one tooth of an upper arch, for purposes of overall teeth alignment. Since the upper arch has more medullary bone than the lower arch, tooth movements are less limited, so the lower arch will now serve as a template for where to position the upper teeth.

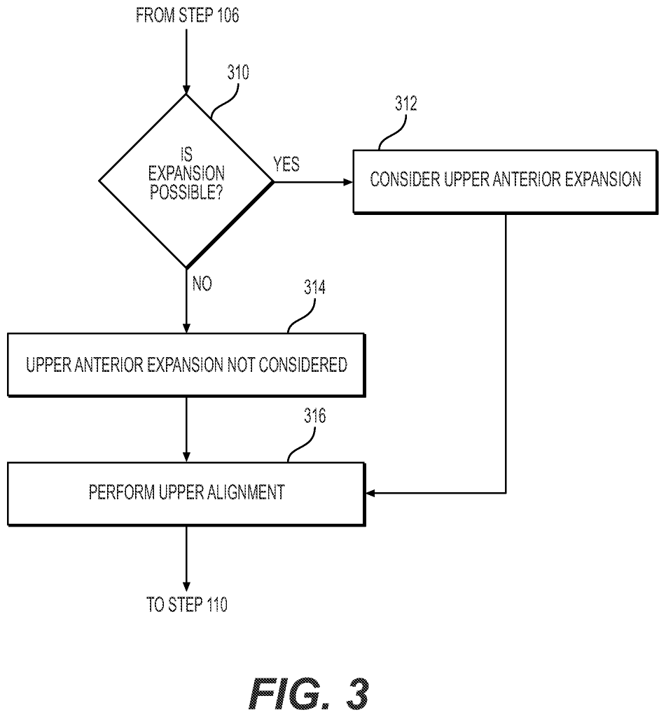

FIG. 3 shows in greater detail an example of how upper arch pre-staging of step 108 is performed, according to one example embodiment herein. In step 310 a determination is made as to whether upper anterior/buccal expansion is possible. By example only, this determination can be based on an evaluation of the periodontal health (e.g., the presence of plaque, calculus, inflammation/recession or the like) of the patient's upper teeth/arch, and, in one example embodiment, is performed based on information evaluated/obtained in step 104. If it is determined that the patient's upper teeth/arch are/is healthy (“Yes” in step 310), then upper expansion or repositioning of the upper teeth can be considered (step 312), and the procedure proceeds to step 316, which will be described below. On the other, if it is determined that the patient's upper teeth/arch are/is not healthy (“No” in step 310), then upper anterior expansion should not be considered, and other procedures can be considered such as, by example and without limitation, sequential step distalization, or it can be decided not to treat the upper teeth (step 314).

Step 316 is performed after either of steps 312 and 314 is performed. In step 316, the user can operate an input user interface (such as interface 406 to be described below) to manipulate the 3D model and one or more upper teeth and to perform various procedures in an effort to plan to manipulate, and/or manipulate, the positions and orientations of one or more of the upper teeth of the model, such that, after steps 106 to 108 of FIG. 1 are performed, the upper and lower teeth will be optimally aligned (and placed in a prescribed final arrangement) with regard to function and aesthetics. Step 316 can include various considerations (e.g., based on information obtained in step 104), functions, and procedures. By example only and without limitation, step 316 can include one or more of moving (e.g., displacing) and/or rotating one or more upper teeth (e.g., starting with a molar, in one example), aligning one or more upper teeth, translation, distalization, expansion (where deemed appropriate, such as in a case of “Yes” in step 310), proclination, lingualization, and/or mesialization of one or more upper teeth, and the like, to establish a symmetrical form and dental midline in the 3D model. Step 316 also can include considering and/or performing tipping, torque (torqueing), intrusion, and/or extrusion to achieve those goals. Also, step 316 (and/or 314) can include considering factors such as the curve of Spee, and/or the curve of Wilson of the patient, in manipulating and/or determining how one or more teeth should be manipulated as described above (in step 316). Also, step 316 can include performing Class I/II anterior-posterior/sagittal corrections, which in one example can be addressed in the upper arch with buccal expansion and/or sequential step distalization.

Step 316 also can include, in determining how one or more upper teeth should be manipulated as described above, determining a maximum displacement of the one or more teeth in the upper arch, determining an amount of force that should be applied to one or more teeth in order to move the teeth, determining an amount and/or angle of displacement and/or a travel path of one or more teeth, determining a length of time that the patient should wear an aligner to effect the movement, performing upper anterior expansion (in the case of “Yes” in step 310), determining which teeth should be anchors and which ones to move, performing buccal expansion and/or sequential step distalization, or not treating the teeth (in the case of “No” in step 310), and/or the like, for the upper arch. In one example embodiment herein, step 316 also is performed in order to avoid (or substantially minimize) mesio-distal contact collisions. Also, in one example embodiment herein, step 316 can include determining if anterior/posterior bite ramps would be useful to mitigate deep bites (anterior) or open bites (posterior), and such ramp(s) can be considered/employed in the model as deemed suitable. Each of the foregoing can be based, in one example embodiment, upon results obtained in pre-staging step 104 (and/or lower staging step 106).

An assessment (e.g., an automatic assessment or by an orthodontist/technician) of result(s) of step 316 can be performed. According to an example aspect herein, the method of FIG. 3 is performed without using or considering using attachments, interproximal reduction (IPR), buttons, elastics, metal braces, wires, and, in one example embodiment, the method is performed to avoid or substantially minimize mesio-distal contact collisions.

After step 316, the method of FIG. 1 is returned to and step 110 is performed. Step 110 includes performing final staging articulation/occlusion, and involves treatment planning to define articulation of the lower and upper arches. Step 110 is performed to confirm that staging inter occlusal collisions are compatible with tooth movement and post staging occlusal collisions are both functional and stable, and to confirm that the upper and lower teeth are sufficiently aligned (and placed in a final, prescribed arrangement).

In one example embodiment herein, no IPR preferably is performed, and, in lieu of spacing in one arch and/or performing IPR in the other arch, a change in crown torque on the upper and lower anterior teeth can be performed, preferably to a level sufficient enough to close spaces in one arch and avoid IPR in the opposite arch. Oftentimes there is an anterior inclination (torque) problem, rather than a Bolton Discrepancy. Also in one example embodiment herein, step 110 can include performing aesthetic/artistic positioning of the upper/lower anterior teeth via distal root/mesial crown angulation.

In the foregoing manner, the position, orientation, and alignment of the teeth of the 3D model can be optimized in terms of function and aesthetics and the teeth can be placed in a prescribed final arrangement. In step 112 of FIG. 1, electronic models of one or more dental aligners can be generated, and then manufactured, wherein the aligners have structures that enable the patient's teeth to be incrementally repositioned and/or re-orientated in a manner as planned for/determined in steps 106-110 such that the patient's teeth can be optimally aligned in terms of function and aesthetics, and placed in the prescribed final arrangement. In one example embodiment, the dental aligners are transparent, and are formed of a polymer, plastic or other suitable material. In example embodiments herein, the dental aligners are formed by a manufacturing device (e.g., such as manufacturing device 408 of FIG. 4 to be described below) (e.g., 3D printer) which receives output signals from a computer processor (such as processor 402 described below) defining commands, and positions/orientations of upper and lower teeth, as determined in steps 106-108 (and/or as defined by the generated electronic models of the dental aligners), such that the manufacturing device forms corresponding aligners with geometries that, when each respective aligner is worn for a respective prescribed/predetermined amount of time by the patient, one or more respective teeth are repositioned/re-orientated over the time period in the manner defined by the aligner geometry and the corresponding signal(s) (and electronic models). By virtue of the patient wearing the aligners on his/her teeth, one or more teeth undergo a cumulative translation after being moved cumulatively by the incrementally-worn aligners. Each aligner (a representation of one of which is shown in FIG. 6) has a tooth receiving cavity 602 having a geometry 604 corresponding to an intermediate or final tooth arrangement intended for the aligner (and defined by the signal(s)). The patient's teeth are repositioned/re-orientated from their initial tooth arrangement to a final, prescribed tooth arrangement by virtue of the various incremental aligners being (removably) worn (at least intermittently) over a prescribed time period by the patient. After each incremental aligner is worn by the patient, and the patient's teeth are repositioned/re-orientated accordingly, then the next incremental aligner can be worn by the patient to achieve the next incremental repositioning/re-orientation. This process is performed until each of the aligners has been worn by the patient and the teeth are deemed to be placed in the final arrangement and to achieve optimal alignment. According to an example aspect herein, the process also is performed without requiring use of traditional metal braces, TADs, Class II connectors, headgear, elastics, wires and the like, as were required to reposition a patient's teeth in the prior art. Also according to an example embodiment herein, the process can be performed to overcorrect for an overbite, overjet, leveling curve of Spee/Wilson, rotations, proclinations of teeth, or the like. In other words, the geometry of the aligner(s) may be such that one or more teeth can be moved beyond a final tooth arrangement, to compensate for possible relapse and/or help speed up rate of correction, as determined during the stagings 106-110.

It should be noted that, as represented by the dashed lines in FIG. 1, at least part of one or more of the steps 104-110 can be performed over again in the process of aligning the teeth of the 3D model. By example only, it may be determined during performance of any of the steps 106-110 that at least part of one or more of the earlier-performed steps should be performed again to re-adjust the teeth according to the respective earlier step(s). Then the step(s) can be performed again to the extent deemed suitable, and the method continues as described above.

As described above, preferably the various types of stagings described above are performed to avoid or substantially minimize mesial/distal contact collisions, because movement of teeth with (plastic) aligners can require it, in at least some cases, given that tooth enamel cannot be forced/moved through tooth enamel (whether considering a singular tooth or plural teeth). Also, as described above, various types of considerations can be made, and various types of procedures and functions can be performed, in steps 216 and 316. By example and without limitation, one or more of steps 216 and 316 can involve individual/sequential distalization or step distalization, to enable correction of sagittal (anterior/posterior) malocclusions, without requiring use of elastics/headgear and other mechanisms typically required in the prior art, and while relieving crowding in lieu of collateral/unwanted protrusive movements of anterior teeth. Staging in steps 216 and/or 316 also can include automated (e.g., artificial intelligent) and/or manual movement of teeth to a prescribed curve of Spee and/or Wilson in a flexible grid with, by example and without limitation, 1 mm, 5 mm, or 10 mm increments. Bite Ramps (anterior/posterior) also can be employed (at least in step 316) to mitigate deep bites (anterior) or open bites (posterior).

Also according to an example embodiment herein, staging according to step 110 can include, by example and without limitation, an automatic or manual alignment of a best fit of final staging orthodontic occlusion to augment function/stability/retention of (e.g., clear) aligner treatment. Such staging also can include overcorrection of an overbite, overjet, leveling curve of Spee/Wilson, rotations, proclinations of teeth, or the like.

Also according to one example embodiment herein, a template can be employed and included in the 3D space, wherein the template defies the prescribed arch/teeth arrangement. In this embodiment, the above method steps for aligning teeth in a scan (3D model) can be performed/effected by instructing the teeth (and/or arch) in the scan to become positioned in accordance with the arrangement of the template's arch/teeth. In one example embodiment, the instructing is performed by way of a user interface (e.g., user interface 406 and/or 2300 described below). Also in one example embodiment, the instructing is performing by placing the scanned model over the template (or vice versa) in the 3D space, wherein, as a result, the teeth of the model take the arrangement of those of the template.

A treatment procedure according to an example embodiment herein will now be described, with reference to FIGS. 19-38. FIGS. 19-38 depict an interface 2300 that includes various views of a model 1900 including upper and/or lower arches 1902, 1904, and controls 2310 for viewing the model, in a starting step (S) of a treatment plan for aligning teeth. In one example embodiment herein, the model 1900 is obtained as described above in connection with step 102 of FIG. 1.

The interface 1900 generally also includes a forward control 1906, a reverse control 1908, and a play control 1910. Selection of the play control 1910 enables step-wise scrolling through a plurality of steps S-R of the treatment procedure. The interface 1900 and steps S to R are merely illustrative and nature, and are not intended to be limiting or critical to the invention. Indeed, treatment procedure(s) according to example embodiments herein may include more or less than the number of steps S to R represented in FIGS. 19-38. Moreover, no individual step S to R represented in the figure is critical to any previous or subsequent step, and, in other embodiments, procedures that are represented as being performed over multiple steps can be performed in only a single step, in less than the multiple steps, or more than the multiple steps. Likewise, procedures that are represented as being performed in a single step, can be performed in more than the single step, depending on the application of interest.

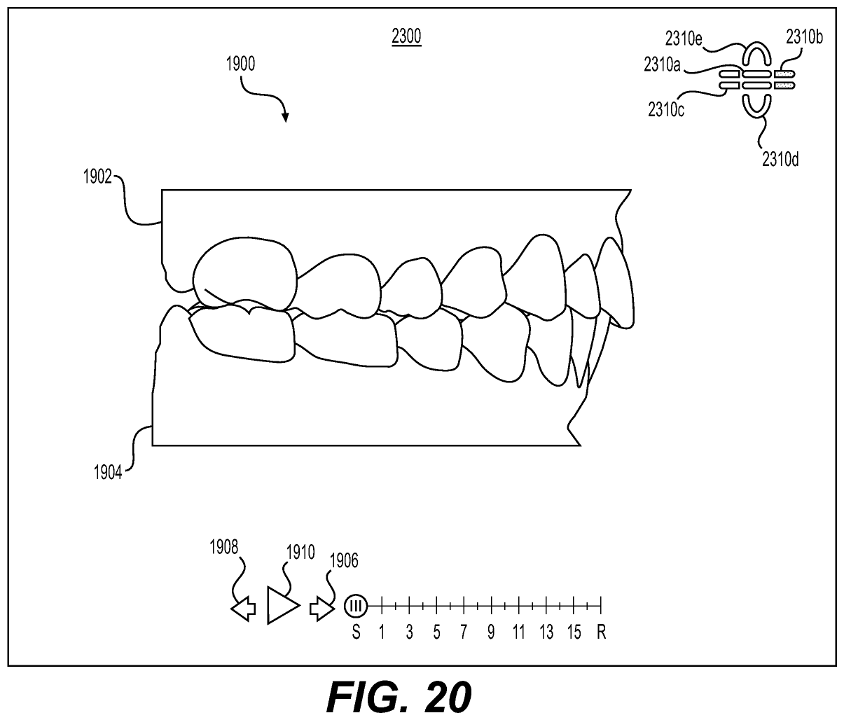

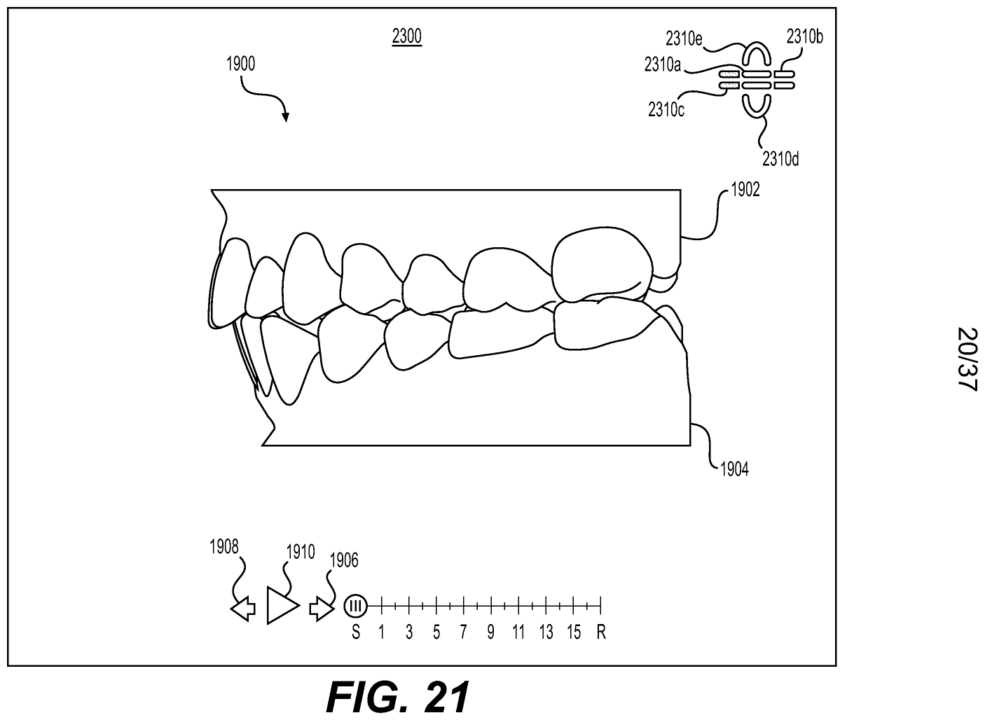

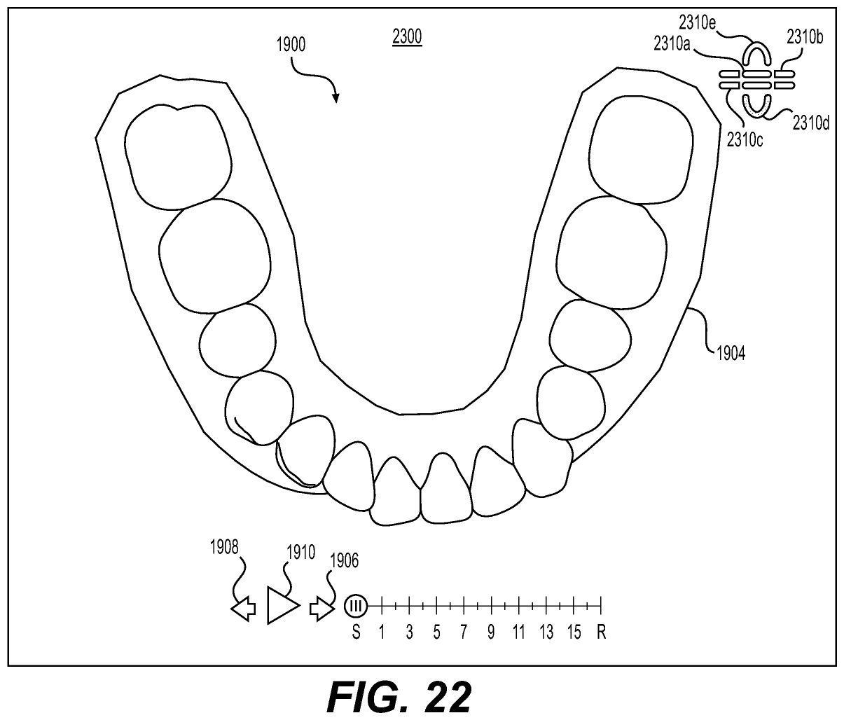

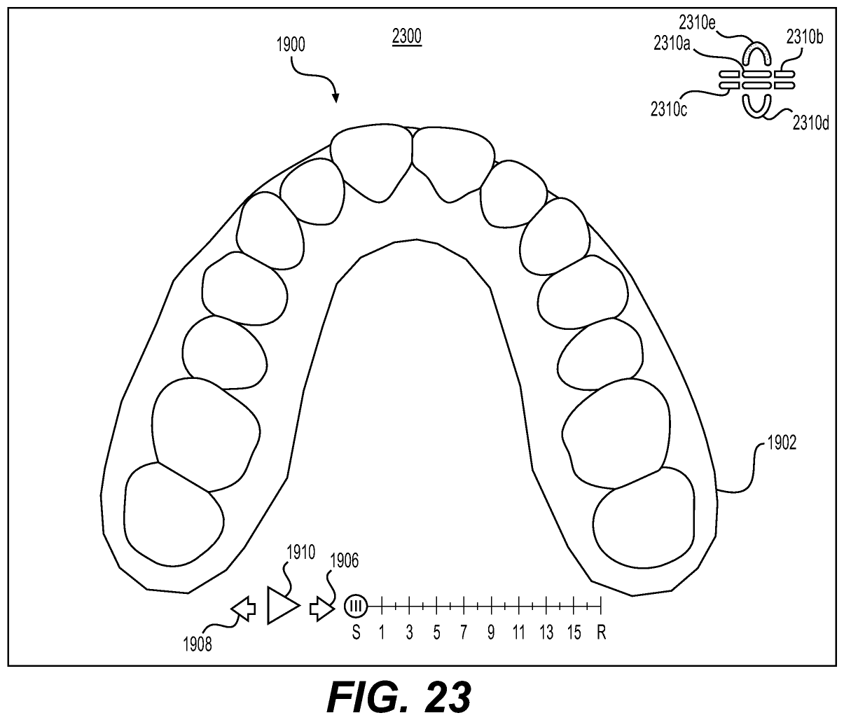

In FIG. 19, control 2310a is shown selected, and, as a result of that selection, the interface 2300 displays a front view of a model 1900 of an upper arch 1902 and lower arch 1904 of a patient, in the starting step (S) of the treatment plan. In FIG. 20, control 2310b is shown selected, and, as a result of that selection, the interface 2300 displays a left side view of the model 1900 of upper and lower arches 1902, 1904. In FIG. 21, control 2310c is shown selected, and, as a result of that selection, the interface 2300 displays a right side view of the model 1900 of the upper and lower arches 1902, 1904. In FIG. 22, control 2310d is shown selected, and, as a result of that selection, the interface 2300 displays the lower arch 1904 of the model 1900. In FIG. 23, control 2310e is shown selected, and, as a result of that selection, the interface 2300 displays the upper arch 1902 of the model 1900.

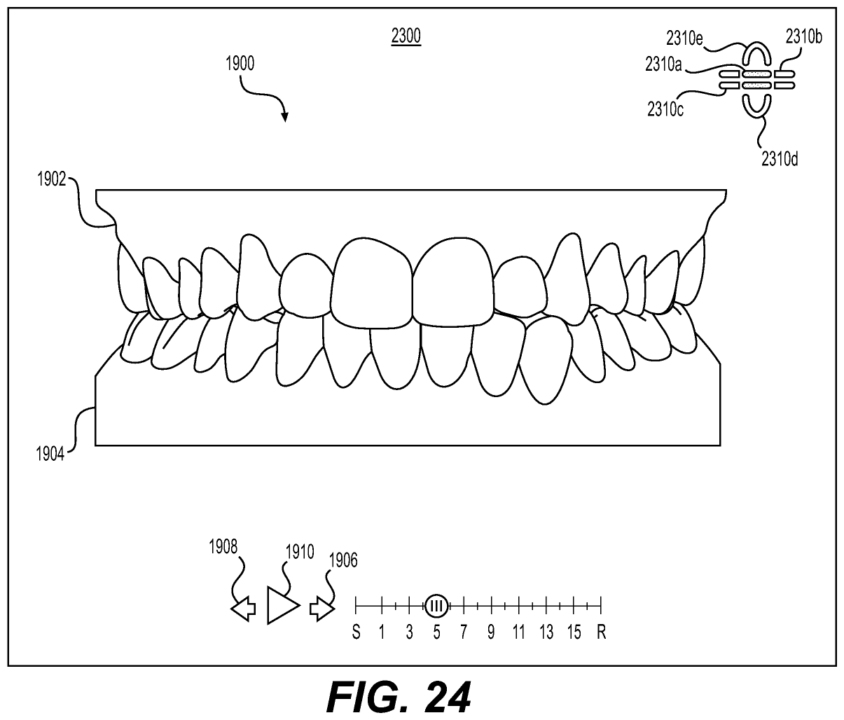

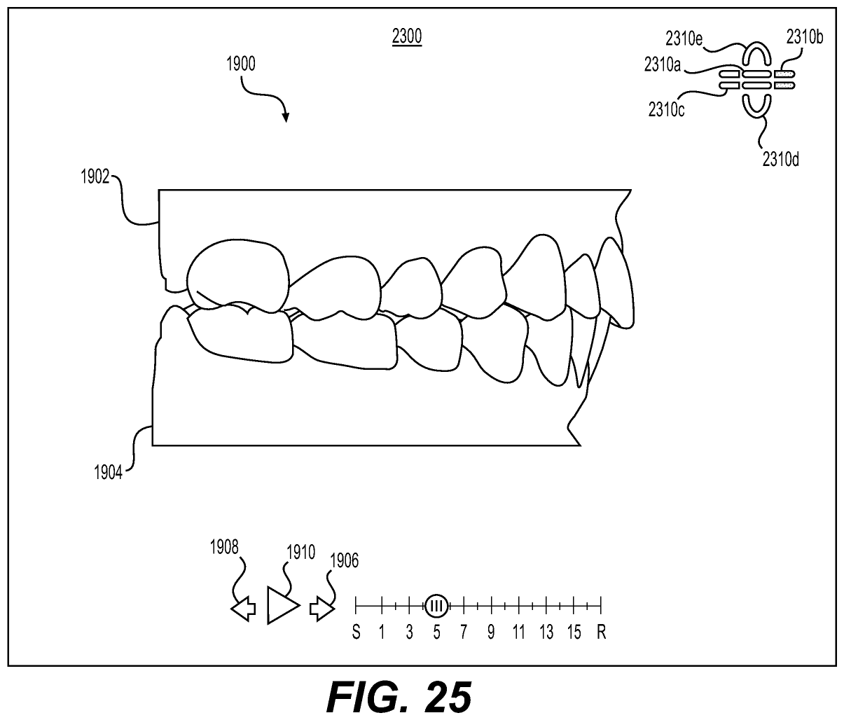

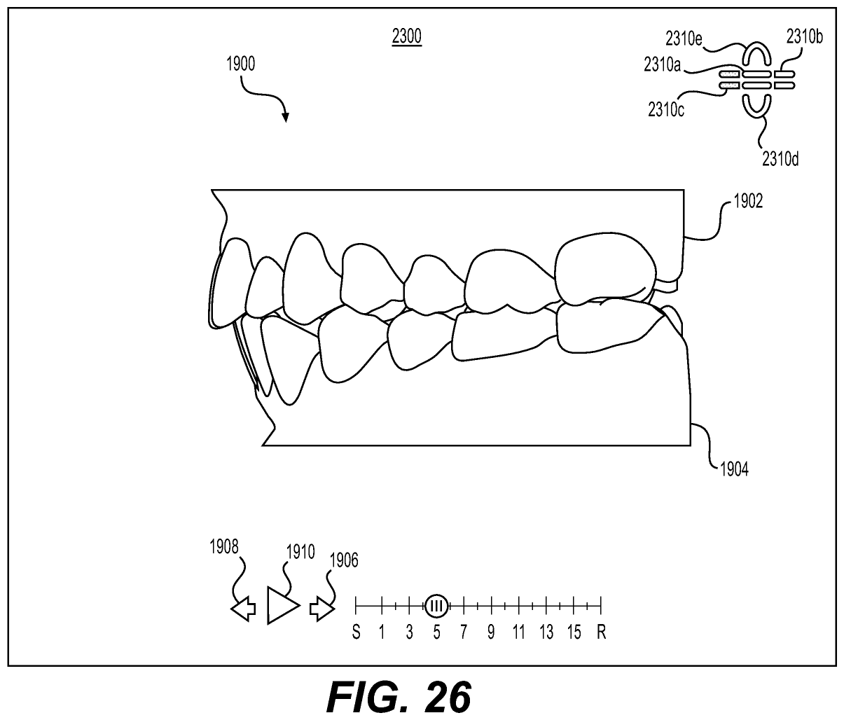

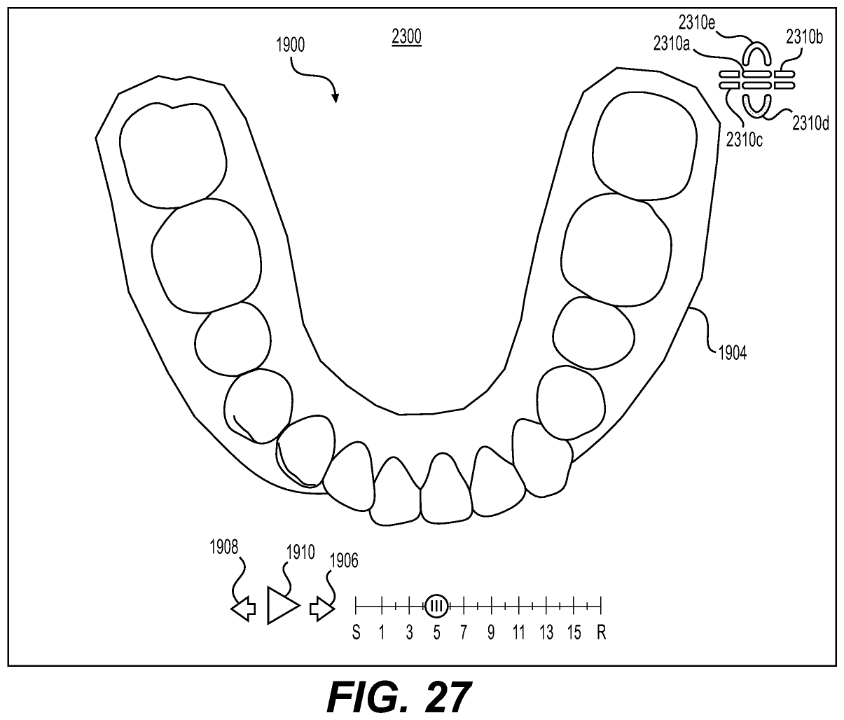

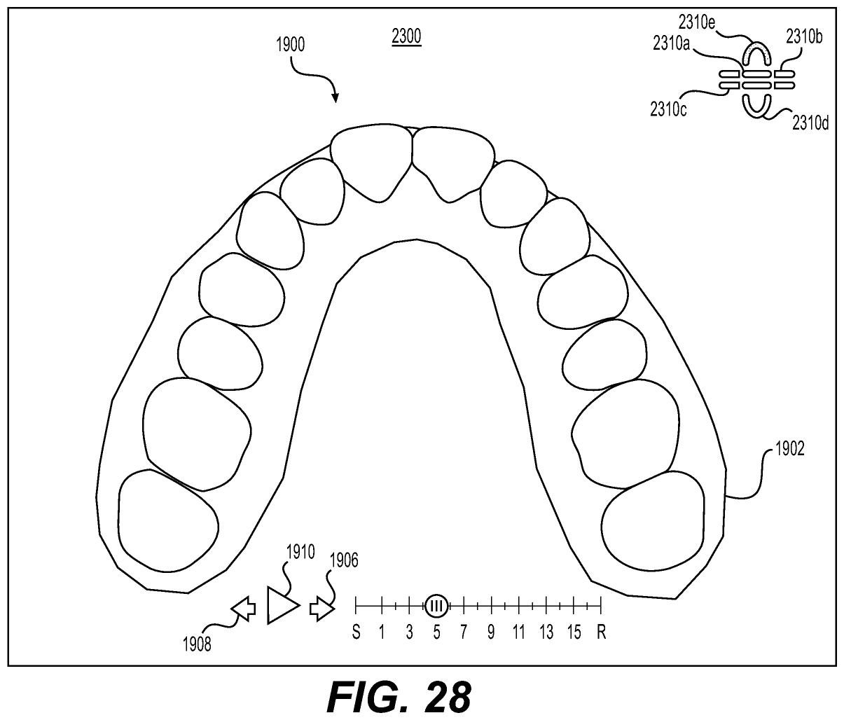

In FIG. 24, control 2310a is shown selected, and, as a result of that selection, the interface 2300 displays a front view of the model 1900 of the upper arch 1902 and lower arch 1904, in a step 5 of the treatment plan. In FIG. 25, control 2310b is shown selected, and, as a result of that selection, the interface 2300 displays a left side view of the model 1900 of upper and lower arches 1902, 1904, in step 5 of the treatment plan. In FIG. 26, control 2310c is shown selected, and, as a result of that selection, the interface 2300 displays a right side view of the model 1900 of the upper and lower arches 1902, 1904, in step 5 of the treatment plan. In FIG. 27, control 2310d is shown selected, and, as a result of that selection, the interface 2300 displays the lower arch 1904 of the model 1900, in step 5 of the treatment plan. In FIG. 28, control 2310e is shown selected, and, as a result of that selection, the interface 2300 displays the upper arch 1902 of the model 1900, in step 5 of the treatment plan.

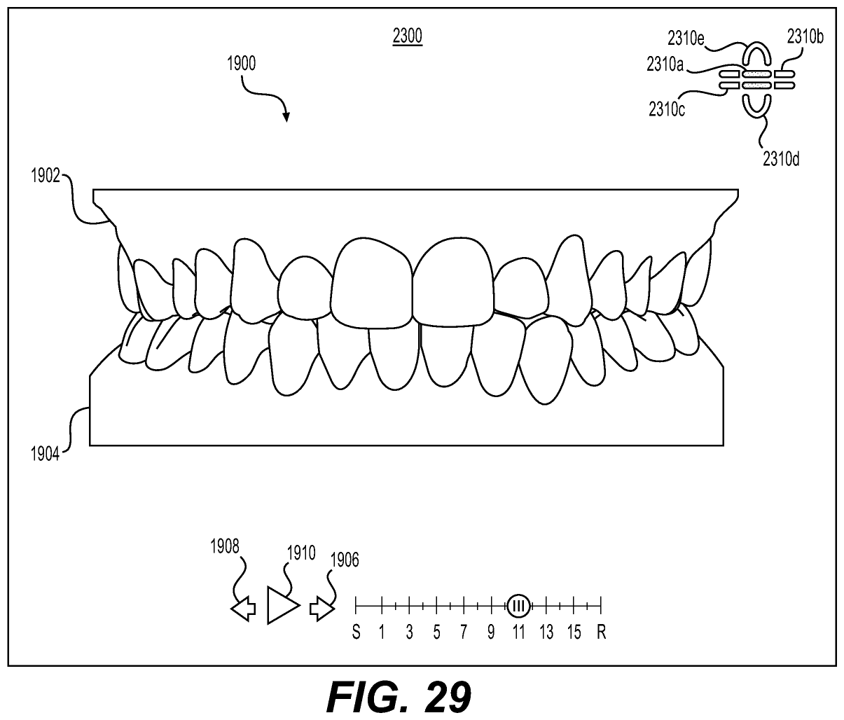

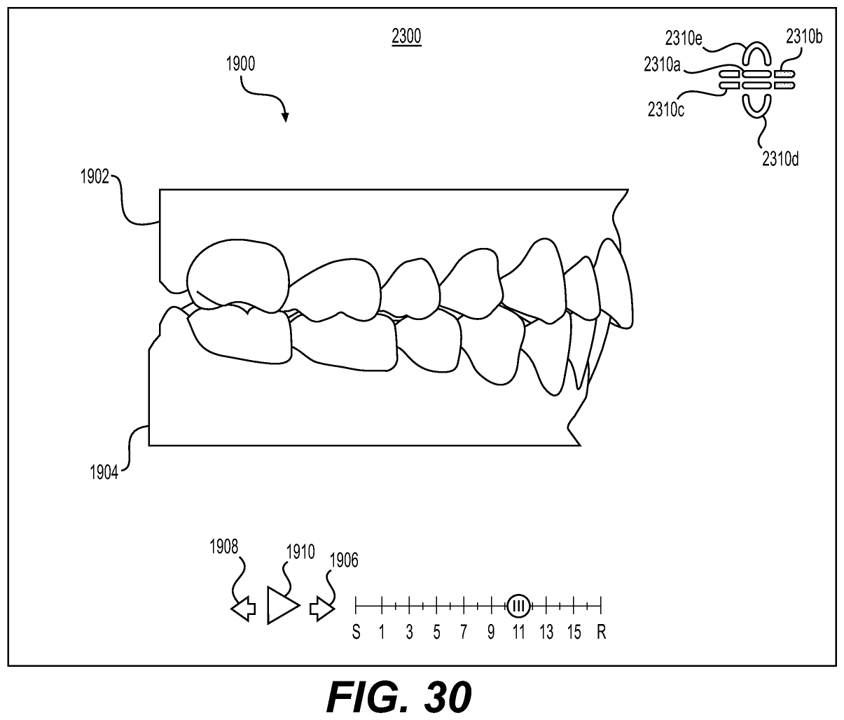

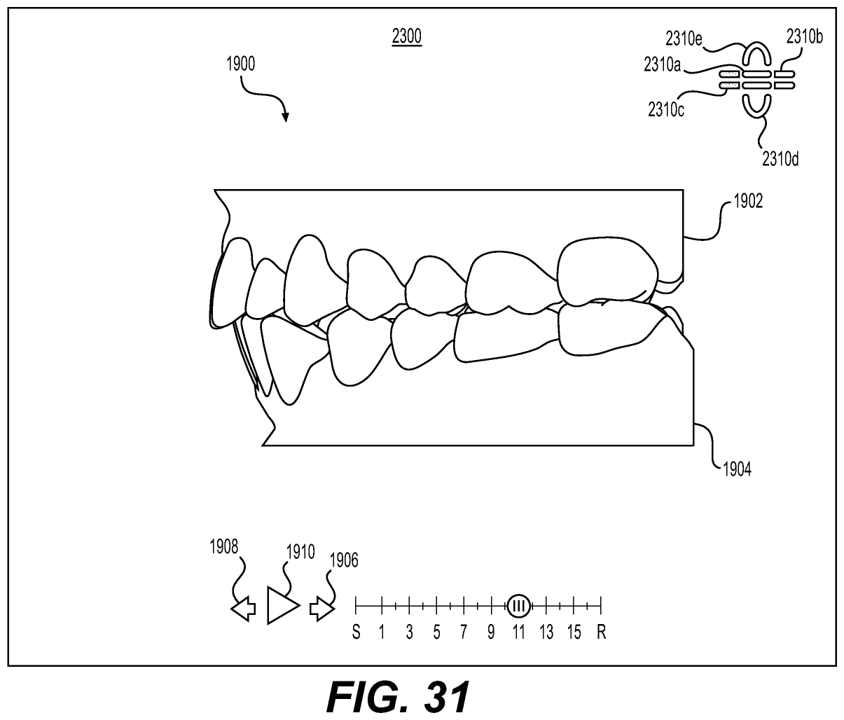

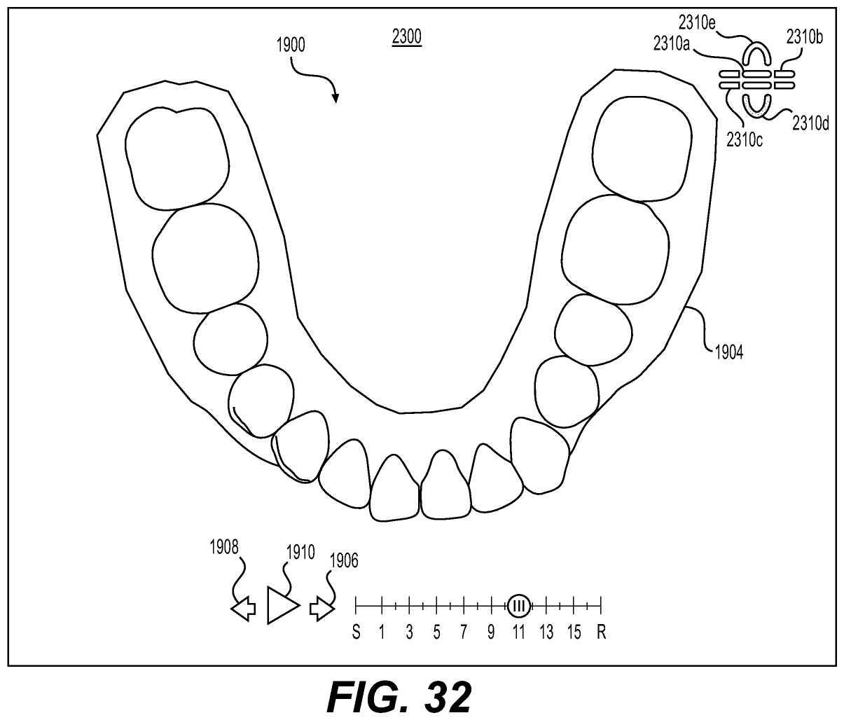

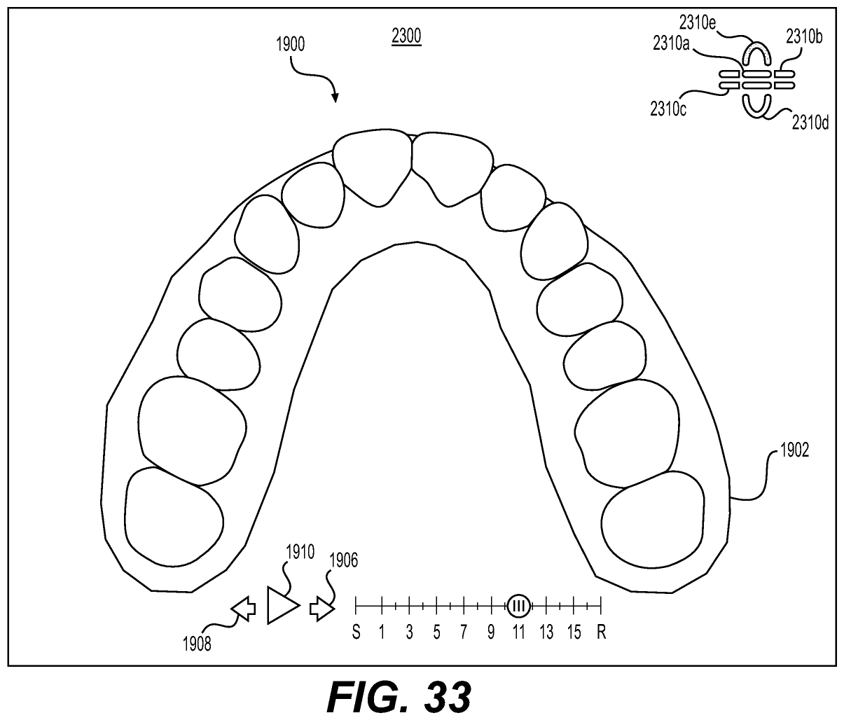

In FIG. 29, control 2310a is shown selected, and, as a result of that selection, the interface 2300 displays a front view of the model 1900 of the upper arch 1902 and lower arch 1904, at a step 11 of the treatment plan. In FIG. 30, control 2310b is shown selected, and, as a result of that selection, the interface 2300 displays a left side view of the model 1900 of upper and lower arches 1902, 1904, at step 11 of the treatment plan. In FIG. 31, control 2310c is shown selected, and, as a result of that selection, the interface 2300 displays a right side view of the model 1900 of the upper and lower arches 1902, 1904, at step 11 of the treatment plan. In FIG. 32, control 2310d is shown selected, and, as a result of that selection, the interface 2300 displays the lower arch 1904 of the model 1900, at step 11 of the treatment plan. In FIG. 33, control 2310e is shown selected, and, as a result of that selection, the interface 2300 displays the upper arch 1902 of the model 1900, at step 11 of the treatment plan.

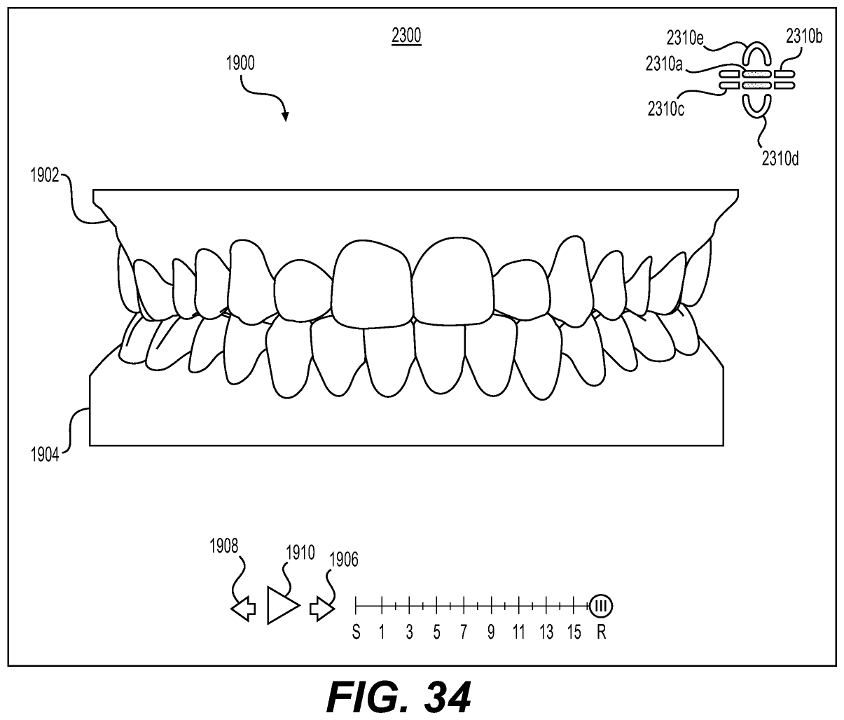

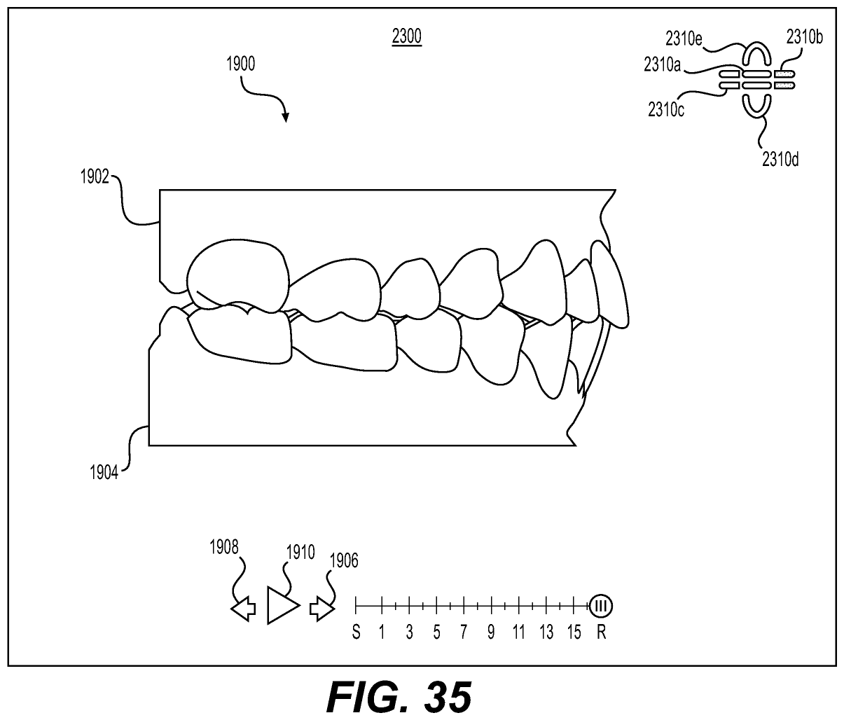

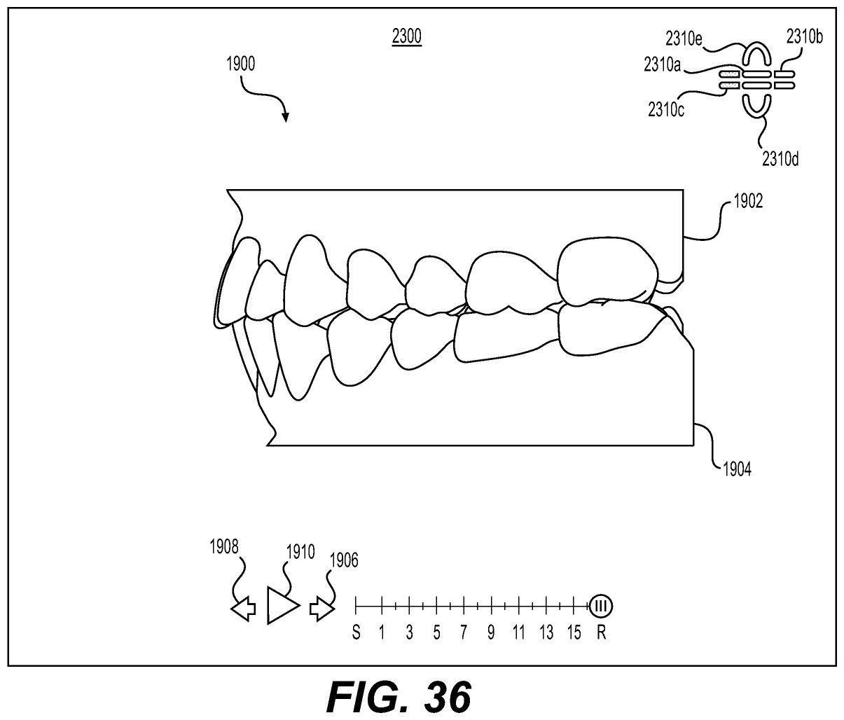

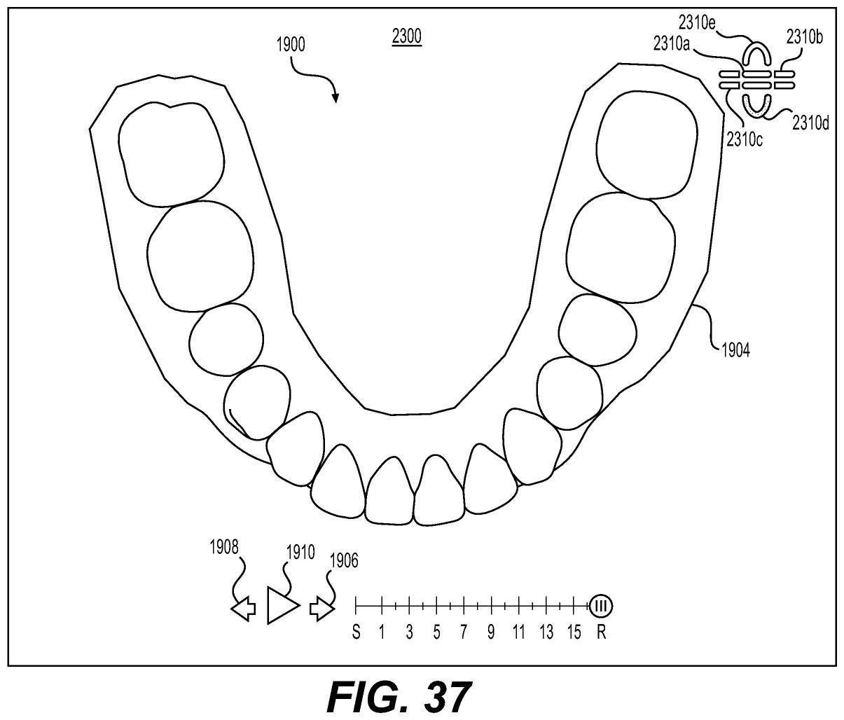

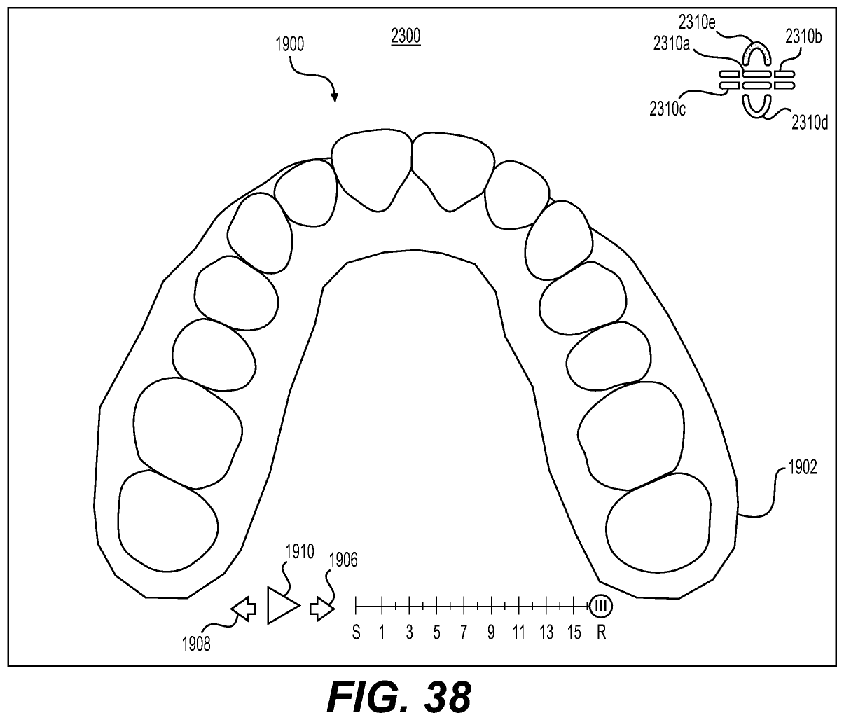

In FIG. 34, control 2310a is shown selected, and, as a result of that selection, the interface 2300 displays a front view of the model 1900 of the upper arch 1902 and lower arch 1904, at a step R of the treatment plan. In FIG. 35, control 2310b is shown selected, and, as a result of that selection, the interface 2300 displays a left side view of the model 1900 of upper and lower arches 1902, 1904, at step R of the treatment plan. In FIG. 36, control 2310c is shown selected, and, as a result of that selection, the interface 2300 displays a right side view of the model 1900 of the upper and lower arches 1902, 1904, at step R of the treatment plan. In FIG. 37, control 2310d is shown selected, and, as a result of that selection, the interface 2300 displays the lower arch 1904 of the model 1900, at step R of the treatment plan. In FIG. 38, control 2310e is shown selected, and, as a result of that selection, the interface 2300 displays the upper arch 1902 of the model 1900, at step R of the treatment plan.

According to one example embodiment herein, treatment according to one or more of FIGS. 19-23 can include one or more of aligning, rotating, and/or buccally expanding teeth, such as, in one example, teeth of at least the lower arch 1904. In some example embodiments herein, one or more of such procedures can be performed in cases in which, by example only, premolars do not have proper alignment and/or mesial/distal rotation. Then, if deemed appropriate, step distalization of the teeth of the lower arch 1904 can be performed to minimize/prevent anterior proclination/protrusion of the lower anterior teeth. By example only, distalization can be performed when the lower anterior periodontal health is deemed compromised, such in cases where there is gingival recession, loss of attached gingiva, and/or thin labial soft tissue/alveolar bone support. In one example embodiment herein, procedures according to the foregoing can be performed in accordance with corresponding parts of step 106 of FIG. 1.

A next part of the treatment according to one or more of FIGS. 19-23 can include fitting teeth of the upper arch 1902 to teeth of the lower arch 1904, while using the lower arch 1904 as a reference/template. In one example embodiment herein, procedures according to this part of the treatment can be performed in accordance with corresponding parts of step 108 of FIG. 1, and can be performed by a user operating the user interface 2300 (e.g., user interface(s) 406) to manipulate one or more teeth of model 1900 to effect the treatment, using a template in the interface or by manipulating such teeth without the template.

In one example embodiment herein, the fitting includes no more than a predetermined number of steps (e.g., sixteen steps, twenty steps, or another predetermined number of steps), and the treatment includes no more than a predetermined number of steps per arch (e.g., twelve steps, sixteen steps, or another predetermined number of steps per arch), although in other example embodiments, the procedure can include any other number of steps and any number of steps per arch, as deemed appropriate to achieve desired teeth alignment. Preferably, it is confirmed that there are no mesial/distal tooth contact collisions during stagings of all tooth movements. Also in one example embodiment herein, the treatment procedure involves no attachments, no IPRs, and no extractions, although in some embodiments, they can be included. By example only, in some embodiments, extractions can be performed for molars (e.g., third molars) and lower incisor(s).

Also in one example embodiment herein, the treatment according to one or more of FIGS. 19-23 involves tooth movement velocities based on 14 day wear of a dental aligner, for 22 hours per day per step. In one example embodiment herein, a maximum tooth movement velocity is about 0.3 mm, or 3° per step. These examples are not exclusive. The treatment according to one or more of FIGS. 19-23 can include continuously confirming that maximum intrusive tooth movement is not greater than 1 mm per tooth, and, in one example embodiment herein, extrusive tooth movement is not greater than 0.5 mm per tooth (or, 0.1 mm per step, in some cases), with velocity of tooth movement distributed over as many steps as possible. Maximum step distalization tooth movement velocities, in one example embodiment herein, mirror maximum tooth movement velocities of 0.3 mm, or 3° per step.

In one example embodiment herein, there can be a limit on the number of simultaneous tooth movements that are performed, for example, in a particular treatment step. By example only, a maximum number of simultaneous tooth movements can be six or seven teeth per step, although in other example, another maximum number or no maximum number can be employed.

In addition, according to an example embodiment herein, both the upper and lower arches 1902, 1904 of the patient can be treated in the treatment according to one or more of FIGS. 19-23, even if only a single one of the arches 1902, 1904 is directed to be treated by prescription. However, in other embodiments, both arches 1902, 1904 do not need to be treated in the treatment plan. Preferably, the treatment involves confirming that there are no mesial/distal tooth contact collisions in staging movements.

According to one example embodiment herein, treatment according to one or more of FIGS. 24-38 can include confirming broad SYMMETRICAL Arch Forms, and/or can be performed according to corresponding parts of step 110 of FIG. 1. If x-bite or a constricted arch form is detected, then the lower arch 1904 can be expanded (e.g., via coronal buccal tipping movements) and the upper arch 1902 form can be over expanded (e.g., via buccal translation/bodily movements). As an illustrative example only, molar movements of 1.5 mm can be performed, premolar movements of 1.0 mm can be performed, and canine movements of 0.5 mm can be performed, beyond ideal on each side, although in practice there is seldom a need to over expand teeth of the lower arch.

Also in one example embodiment herein, unilateral expansion preferably is avoided, and/or only performed where deemed necessary, with attention paid to a broad symmetrical arch form, although this example is not limiting.

Also in one example embodiment herein, step distalization (primarily)/step mesialization (which, for some patients, is rarely performed), when performed, is done so to avoid any in mass (e.g., 1 or more teeth) tooth movements. Step distalization, in one example embodiment herein, can occur in increments of 0.3 mm or 0.6 mm. If third molars are marked as removed (e.g., in a supporting document), step distalization can be performed for molars, as required on a case-by-case basis. Step distalization can be difficult in quadrants where third molars are present (e.g., where they are impacted/partially impacted/erupted). As such, if third molars are marked as not removed (e.g., in a supporting document) or present in the scan/models, step distalization can be limited to a predetermined maximum (e.g., 1 mm).

In one example embodiment herein, unilateral step preferably distalization is avoided, with attention paid to the upper/lower dental midlines (and only if deemed necessary), although this example is not limiting.

Also, during treatment according to one or more of FIGS. 24-38, non-contact/uncoupled anterior occlusion preferably is confirmed/performed. In one example embodiment herein, this can be performed by or based on (i) palatal root/labial crown torque to upper incisors, (ii) more acute inter-incisal angle (when teeth are too upright), and/or (iii) distal root/mesial crown angulation, all to provide some space between the lingual of the upper incisors and incisal edge or facial of the lower incisors. Thus, preferably anterior occlusion can be uncoupled to prevent posterior open bites following clear aligner treatment.

According to an example embodiment herein, during treatment according to one or more of FIGS. 24-38, it is confirmed that there is no IPR/No Spaces. In one example embodiment herein, in lieu of spacing in one arch and/or IPR in the other arch, the crown torque on the upper and lower anterior teeth can be changed, preferably enough to close spaces in one arch and avoid IPR in the opposite arch. Often, there is an anterior inclination (torque) problem to address, rather than a Bolton Discrepancy. Palatal root/buccal crown torque and/or distal root/mesial crown angulation of the upper anterior teeth can be performed.

Also during treatment according to one or more of FIGS. 24-38, Aesthetic/Artistic positioning of the upper/lower anterior teeth preferably is confirmed such as via distal root/mesial crown angulation, although this example is non-limiting. In one example embodiment herein, upper anterior bite ramps can be employed for patients with deep bites, U2-2 or U3's depending on malocclusion.

In one example embodiment herein, to not close all spaces is allowed during treatment according to one or more of FIGS. 24-38, but only if there is an existing extraction space present, or a specific directive from a treating orthodontist. In another example embodiment herein, all or at least some spaces are closed unless there is an existing extraction space present, or a specific directive from the treating orthodontist. Of course, these examples are non-limiting, and, in other examples there may be variations therefrom.

Also in one example embodiment herein, as a last option to closing spaces, a negative smile line can be created. A bridge can be moved transversely as a single unit if identified or mentioned in a medical form or medical/dental history (e.g., x-rays), and deemed necessary.

In one example embodiment herein, during treatment according to one or more of FIGS. 24-38, at the treating orthodontist's discretion, cases can be processed with retained deciduous/primary teeth, but these teeth preferably cannot be moved.

Also, preferably during such treatment, lower incisors are not moved forward from their intended final position(s) (e.g., round tripping), in order to avoid or substantially minimize occlusal interferences, mobility, trauma, etc., although this example is not limiting. Preferably, Posttreatment Overjet should not be made worse than the Pretreatment Overjet, although this example also is not limiting.

In the foregoing manner according to the treatment of FIGS. 19-38, the position, orientation, and alignment of the teeth of the model 1900 can be optimized in terms of function and aesthetics and the teeth can be placed in a prescribed final arrangement. Thereafter, one or more dental aligners can be generated/manufactured that have structures that enable the patient's teeth to be incrementally repositioned and/or re-orientated in a manner as planned for/determined according to FIGS. 19-38 (e.g., and steps 106-110) such that the patient's teeth can be optimally aligned in terms of function and aesthetics, and placed in the prescribed final arrangement. In one example embodiment, the dental aligners are generated/manufactured as described above in connection with step 112 of FIG. 1, and have a construction as represented in FIG. 6, although these examples are not limiting.

In example embodiments herein, the dental aligners have geometries that, when each respective aligner is worn for a respective prescribed/predetermined amount of time by the patient, one or more respective teeth are repositioned/re-orientated over the time period in the manner defined by the aligner geometry and the corresponding signal(s). By virtue of the patient wearing the aligners on his/her teeth, one or more teeth undergo a cumulative translation after being moved cumulatively by the incrementally-worn aligners.

In one example embodiment herein, each aligner (a representation of one of which is shown in FIG. 6) generated/manufactured as described above has tooth receiving cavity 602 having geometry 604 corresponding to an intermediate or final tooth arrangement intended for the aligner (and defined by the signal(s)). As but one illustrative example, each respective aligner has a corresponding cavity 602 and geometry 604 corresponding to a respective one of the steps S-R represented in FIGS. 19-38. As but one illustrative example and without limitation, after an aligner having a cavity 602 and geometry 604 corresponding to step 5 is manufactured and then worn by the patient over a prescribed period of time, the patient's teeth are repositioned/re-orientated from their pre-existing tooth arrangement to a tooth arrangement specified by step 5 (e.g., an arrangement arrived at in step 5, after the procedures for that step have been performed). Similarly, after an aligner having a cavity 602 and geometry 604 corresponding to step 11 is manufactured and then worn by the patient over a prescribed period of time, the patient's teeth are repositioned/re-orientated from their pre-existing tooth arrangement to a tooth arrangement specified by step 11 (e.g., an arrangement arrived at in step 11, after the procedures for that step have been performed). After each incremental aligner is worn by the patient, and the patient's teeth are repositioned/re-orientated accordingly, then the next incremental aligner (corresponding to a particular step S-R) can be worn by the patient to achieve the next incremental repositioning/re-orientation. This process is performed until each of the aligners has been worn by the patient and the teeth are deemed to be placed in the final arrangement and to achieve optimal alignment. In one non-limiting example embodiment herein, the final arrangement is in accordance with the tooth arrangement specified by step R (e.g., an arrangement arrived at in step R, after the procedures for that step have been performed) (in one example embodiment, “R” represents “ready for aligners”).

In one non-limiting example embodiment herein, each aligner preferably is worn by the patient for about 14 days, for 22 hours per day, and a maximum tooth movement velocity effected by each aligner is about 0.3 mm, or 3°, although in other examples, other prescriptions may be employed instead.

According to an example aspect herein, wearing of the aligners by the patient is performed without requiring use of traditional metal braces, TADs, Class II connectors, headgear, elastics, wires and the like, as were required to reposition a patient's teeth in the prior art. Also according to an example embodiment herein, the process can be performed to overcorrect for an overbite, overjet, leveling curve of Spee/Wilson, rotations, proclinations of teeth, or the like. In other words, the geometry of the aligner(s) may be such that one or more teeth can be moved beyond a final tooth arrangement, to compensate for possible relapse and/or help speed up rate of correction (e.g., as determined during the stagings 106-110).

According to an example embodiment herein, software and/or interfaces herein can have a capability of performing one or more of superimposition, measurement of grid-horizontal/vertical bold lines (e.g., having a predetermined spacing, such as, without limitation, every 10 mm), inclusion of attachments (e.g., Bite Ramps), Occlusal Contact Collision Detection (e.g., in each step), Mesial/Distal Contact Collision Detection (e.g., in each step), and a 5-View Composite. Also according to an example embodiment herein, software and/or interfaces herein can have a capability of providing one or more of a Tooth Movement Assessment and/or an Icon Summary of tooth movements (e.g., in each step), a Tooth Movements Table, such as one including a Numeric Summary of tooth movements (e.g., for each step), a Bolton Analysis, OverJet/OverBite measurements (e.g., from initial to final), Arch Width-U/L (e.g., 3/4/5/6/7's), and Dynamic Virtual Pontics. Also according to an example embodiment herein, software and/or interfaces herein can have one or more of a capability of setting Occlusal Plane(s) (e.g., Horizontal/Vertical), and performing Tooth Numbering (e.g., Palmer notation, Universal notation, International notation), passive eruption for cases (e.g., for children, adolescents, and at least some adults) where the teeth may need to passively erupt rather than be trapped in a static position). Also according to an example embodiment herein, software and/or interfaces herein can have one or more of a capability of exporting information, setting up information, recording movies and screenshots, STL file(s), and the like. Also according to an example embodiment herein, software and/or interfaces herein can provide one or more of attachments (e.g., button attachments, bite ramps, precision cuts, and/or other dental attachments), IPRs, and locations and amounts thereof.

Example aspects described herein improve the fields of dental and orthodontic methodologies and patient-home care treatment, as well as dental aligners and aligner fabrication, by virtue of providing the procedure(s) and device(s) described herein, and also by virtue of enabling virtual model and patient dental alignments to be performed/achieved in a more reliable, efficient, convenient, accurate, and high-quality manner relative to conventional methods and devices, while avoiding or substantially minimizing use of intrusive, uncomfortable, inconvenient, and oftentimes-inaccurate prior art mechanisms for aligning teeth as described above.

Intellectual Property-Clear aligner At Home/Studio “virtual orthodontics” model (one non-limiting example)
Articulation/Pretreatment Bite Registration: upper/lower occlusal collisions-AI/manual best fit of pre
orthodontic treatment malocclusion, when no bite registration exists to articulate the patient's bite
Pre-Staging: review diagnostic records (individual/collage photos, upper/lower stl/3D files/models,
medical/dental history, absence/presence of third molars, general oral health and periodontal health) to
determine what upper/lower tooth movements are possible for each patient
Lower Arch Staging: begins with the lower arch, since we have less bone, the medullary bone is in a trough
bordered buccal/lingually by cortical bone, resulting in limited tooth movement options. With clear aligners in
an at home “virtual orthodontics” model, anterior-posterior/sagittal correction by anterior movement of the
mandible is challenging without headgear, elastics, TAD's or Class II correctors, so we must be creative in our
setups.
1. determine if lower anterior/buccal expansion is possible, generally determined by evaluating the
periodontal health (plaque/calculus/inflammation/recession) of the lower teeth.
a. if healthy, lower anterior expansion may be considered
b. if not healthy, lower anterior expansion may not be considered, so consider buccal expansion and/or
sequential step distalization or CNT
2. then rotate/align/distalize/tip/torque/intrude/extrude to establish symmetrical archform and dental midline
3. consideration may be given to the curve of spee and curve of wilson
4. Class III anterior-posterior/sagittal corrections are typically addressed in the lower arch with
sequential step distalization
5. all movements must be assessed by the orthodontist/technician and accomplished without
attachments/IPR/buttons/elastics/mesio-distal contact collisions. Candid's design software and
manufacturing of aligners are unique in achieving Candid's Rx and successful outcomes.
Upper Arch Staging: since the upper arch has more medullary bone, tooth movements are less limited, so
the lower arch will now serve as a template for where we position the upper teeth.
1. determine if upper anterior/buccal expansion is possible, generally determined by evaluating the
periodontal health (plaque/calculus/inflammation/recession) of the upper teeth.
a. if healthy, upper expansion may be considered
b. if not healthy, upper expansion may not be considered, so consider sequential step distalization or CNT
2. then rotate/align/distalize/tip/torque/intrude/extrude to establish symmetrical archform and dental midline
3. consideration may be given to the curve of spee and curve of wilson
4. Class I/II anterior-posterior/sagittal corrections are typically addressed in the upper arch with buccal
expansion and/or sequential step distalization
5. determine if anterior/posterior bite ramps are needed to mitigate deep bites (anterior) or open bites
(posterior)
6. all movements must be assessed by the orthodontist/technician and accomplished without
attachments/IPR/buttons/elastics/mesio-distal contact collisions. Candid's design software and
manufacturing of aligners are unique in achieving Candid's Rx and successful outcomes.
Final Staging Articulation/Occlusion: confirm that staging inter occlusal collisions are compatible with tooth
movement and post staging occlusal collisions are both functional and stable
1. No IPR-in lieu of spacing in one arch and/or IPR in the other arch, change the crown torque on the upper and
lower anterior teeth, enough to close spaces in one arch and avoid IPR in the opposite arch. Often there is an
anterior inclination (torque) problem, rather than a Bolton Discrepancy.
2. No IPR-aesthetic/artistic positioning of the upper/lower anterior teeth via distal root/mesial crown angulation
*Staging: “Overlay upper/lower archforms/wires” to establish pre-defined archform and symmetry
*Staging: establish lower arch/teeth first, then best fit the upper teeth to the lower teeth
*Staging: “avoid mesial/distal contact collisions”-the only viable way to move teeth with plastic, since you can't
move/force tooth enamel through tooth enamel. May be singular tooth/plural teeth
*Staging: “individual/sequential distalization” or “Step distalization”-correction of sagittal (anterior/posterior)
malocclusions without elastics/headgear, and relieve crowding in lieu of collateral/unwanted protrusive
movements of anterior teeth.
*Staging: AI/manual movement of teeth to prescribed curve of spee in flexible grid with 1 mm/5 mm/10 mm
increments
*Staging: AI/manual movement of teeth to prescribed curve of wilson in flexible grid with 1 mm/5 mm/10 mm
increments
*Staging: Bite Ramps (anterior/posterior) to mitigate deep bites (anterior) or open bites (posterior)
*Staging: occlusal collisions-AI/manual best fit of final staging orthodontic occlusion to augment
function/stability/retention of clear aligner treatment. Including, but not limited to overcorrection of
overbite/overjet/leveling curve of spee/wilson/rotations/proclination of teeth, etc.
*Staging: No IPR-in lieu of spacing in one arch and/or IPR in the other arch, change the crown torque on the
upper and lower anterior teeth, enough to close spaces in one arch and avoid IPR in the opposite arch. Often
there is an anterior inclination (torque) problem, rather than a Bolton Discrepancy.
*Staging: No IPR-aesthetic/artistic positioning of the upper/lower anterior teeth via distal root/mesial crown
angulation

FIG. 4 is a diagram of an example data processing system 400. The system 400 of FIG. 4 includes a processor 402, a memory 403, a storage device 404, a communications device 405, a manufacturing device 408, a scanner 410, and user interfaces 406, all of which are coupled to a bus 401.

The processor 402 can communicate with the other components of the architecture through the bus 401. The storage device 404 includes one or more machine-readable media. The storage device 404 can be configured to read and write data including program instructions that may be executed by the processor 402 and operating systems (e.g., Microsoft Windows, UNIX) that allow the processor 402 to control the operation of the other components. The communications device 405 can be configured to allow the processor 402 to communicate with, e.g., a network and the internet. The user interfaces 406 can include input devices (e.g., keyboards, mice, joysticks, trackpads, stylus tablets, microphones, and cameras, and the like) and output devices (e.g., displays, printers, speakers, and the like). The user interfaces 406 can comprise, at least in part, any of the interfaces or displays discussed herein. The user interfaces 406 can enable a user to, among other things, view and manipulate 3D models displayed in virtual space, as described herein, and can include, in one example embodiment herein, interface 2300.

The processor 402 may be configured to communicate with other components of the system 400, issue commands, receive scans from the scanner 410, and the like, and is configured to perform any of the procedures (at least in part) described herein and shown in the drawings. For example, the procedures may be stored on the storage device 404 in the form of machine-readable program instructions. To execute a procedure, then, the processor loads the appropriate instructions, as stored on the storage device 404, into the memory 403, and then executes the loaded instructions to perform at least part of the procedures herein. During the course of the procedures (including, without limitation, steps 102-110 of FIG. 1), the processor 402 can generate commands, as well as initial, intermediate and final data/signals/information representative of determinations made during the procedure, and/or computer models (e.g., of dental aligners) generated during the procedure, and can provide any such data/signals/information/models to other components of the system 400, such as, without limitation, manufacturing device 408 and user interface(s) 406.

The manufacturing device 408 fabricates dental appliances such as dental aligners (e.g., FIG. 6) based on initial, intermediate and final data/signals/information and/or generated models received from processor 402, such as information/models determined/provided/generated by processor 402 during the performance of steps 102-110 of FIG. 1 and defining specific aligner geometries that can effect prescribed tooth movements on a patient of interest. The manufacturing device 408 can include any suitable type of fabrication device for fabricating dental aligners, such as, by example and without limitation, 3D printers, CAD printers, etc.

Scanner 410 can scan or otherwise acquire scans of casts of a patient's teeth/arch and/or a reproduction thereof (e.g., in step 102 of FIG. 1), and provides scan information/digital data to processor 402 for processing. The system 400 also can acquire scans from an external source by way of communications device 405, over a network or local connection.

In the foregoing description, example aspects of the invention are described with reference to specific example embodiments thereof. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention.

Software embodiments of example aspects described herein may be provided as a computer program product, or software, that may include an article of manufacture on a machine accessible or machine readable medium (memory) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine readable medium,” or “memory” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs.

In addition, it should be understood that the figures illustrated in the attachments, which highlight the functionality and advantages of the present invention, are presented for example purposes only. The architecture of the example aspect of the present invention is sufficiently flexible and configurable, such that it may be utilized (and navigated) in ways other than that shown in the accompanying figures.

Although example aspects of this invention have been described in certain specific embodiments, many additional modifications and variations would be apparent to those skilled in the art. It is therefore to be understood that this invention may be practiced otherwise than as specifically described. Thus, the present example embodiments, again, should be considered in all respects as illustrative and not restrictive.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

In addition, it should be understood that the Figures are presented for example purposes only. The architecture of the example embodiments presented herein is sufficiently flexible and configurable, such that it may be utilized (and navigated) in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

1. A method for orthodontic treatment planning, comprising:
providing a dental appliance having a geometry based on a lower arch stage of treatment planning defining movement of at least one tooth of a lower arch;
providing a dental appliance having a geometry based on an upper arch stage of treatment planning defining movement of at least one tooth of an upper arch; and
providing a dental appliance having a geometry based on a final arch stage of treatment planning defining articulation of the lower and upper arches,
wherein the upper arch stage of treatment planning involves fitting teeth of the upper arch to teeth of the lower arch, while using the lower arch as a reference.

2. The method of claim 1, wherein the providings provide the dental appliances by controlling a manufacturing device to fabricate the dental appliances.

3. The method of claim 1, wherein the upper arch stage of treatment planning, the lower arch stage of treatment planning, and the final arch stage of treatment planning align teeth of the upper and lower arches.

4. The method of claim 1, wherein the upper and lower arches are included in a computer model.

5. The method of claim 1, wherein the geometries of the dental appliances differ from one another.

6. The method of claim 1, wherein the dental appliances are wearable by a patient, and wherein successive wears by the patient of respective ones of the dental appliances manipulate teeth of the patient to a final teeth arrangement.

7. The method of claim 1, wherein the movements avoid tooth collisions.

8. The method of claim 1, wherein at least one of the upper arch stage of treatment planning or the lower arch stage of treatment planning includes a distalization to correct a malocclusion.

9. The method of claim 1, wherein at least one of the movements is in accordance with at least one of a prescribed curve of Spee or a prescribed curve of Wilson.

10. The method of claim 1 where at least one of the dental appliances is a computerized model dental appliance.

11. The method of claim 1, wherein the movements include one or more of displacing, rotating, aligning, a translation, distalization, expansion, proclination, lingualization, mesialization, tipping, torqueing, intrusion, and extrusion of the at least one tooth.

12. The method of claim 1, wherein the final arch stage of treatment planning includes one or more of performing a change in crown torque on at least one tooth, performing aesthetic positioning of at least one tooth, and substantially avoiding interproximal reduction.

13. A system for positioning a patient's teeth, comprising a plurality of dental appliances having respective geometries determined based on a lower arch stage of treatment planning, an upper arch stage of treatment planning, and a final arch stage of treatment planning, the lower arch stage of treatment planning defining movement of at least one tooth of a lower arch, the upper arch stage of treatment planning defining movement of at least one tooth of an upper arch, and the final arch stage of treatment planning defining articulation of the lower and upper arches, wherein the dental appliances are wearable on teeth of a patient, wherein successive wears on the teeth of the patient of respective ones of the dental appliances manipulate the teeth of the patient to a final teeth arrangement, and wherein the upper arch stage of treatment planning involves fitting teeth of the upper arch to teeth of the lower arch, while using the lower arch as a reference.

14. The system of claim 13, wherein the dental appliances manipulate the teeth of the patient without causing tooth collisions.

15. The system of claim 13, wherein, in the final teeth arrangement, the teeth of the patient are substantially aligned.

16. A system for orthodontic treatment planning, comprising:
a processor; and
a storage medium storing computer-readable instructions that, when executed by the processor, cause the processor to perform a method comprising:
providing dental appliances having geometries defining a lower arch stage of treatment planning, an upper arch stage of treatment planning, and a final arch stage of treatment planning, the lower arch stage of treatment planning defining movement of at least one tooth of a lower arch, the upper arch stage of treatment planning defining movement of at least one tooth of an upper arch, and the final arch stage of treatment planning defining articulation of the lower and upper arches, wherein the upper arch stage of treatment planning involves fitting teeth of the upper arch to teeth of the lower arch, while using the lower arch as a reference.

17. The system of claim 16, further comprising a user interface coupled to the processor and arranged to present a computer model of at least one of the lower arch or the upper arch to a user.

18. The system of claim 16, further comprising a manufacturing device coupled to the processor, wherein the processor provides the dental appliances by controlling the manufacturing device to cause the manufacturing device to fabricate physical dental appliances wearable by a patient.

19. The system of claim 18, wherein the dental appliances are wearable on teeth of a patient, and wherein successive wears on the teeth of the patient of respective ones of the dental appliances manipulate the teeth of the patient to a final teeth arrangement.

20. A computer-readable storage medium storing instructions which, when executed by a computer processor, cause the computer processor to perform a method for orthodontic treatment planning, the method comprising:
providing dental appliances having geometries determined based on a lower arch stage of treatment planning, an upper arch stage of treatment planning, and a final arch stage of treatment planning, the lower arch stage of treatment planning defining movement of at least one tooth of a lower arch, the upper arch stage of treatment planning defining movement of at least one tooth of an upper arch, and the final arch stage of treatment planning defining articulation of the lower and upper arches, wherein the upper arch stage of treatment planning involves fitting teeth of the upper arch to teeth of the lower arch, while using the lower arch as a reference.

21. The system of claim 13, wherein at least one of the dental appliances manipulates the teeth to cause anterior-posterior/sagittal correction by anterior movement of a mandible.

22. The system of claim 13, wherein the geometries of the dental appliances, when worn by the patient, cause movement of at least one tooth of a lower arch of the patient, movement of at least one tooth of an upper arch of the patient, and articulation of the lower and upper arches of the patient.

23. The system of claim 22, wherein a maximum tooth movement velocity effected by each movement is about 0.3 mm, or 3°.

24. The system of claim 13, wherein at least one of the geometries causes movement of at least one tooth beyond the final tooth arrangement to compensate for relapse or to speed teeth correction.

25. The system of claim 16, wherein the dental appliances are computer model dental appliances.

26. The computer-readable storage medium of claim 20, wherein the dental appliances are one of computerized model dental appliances or non-computerized dental appliances.

27. A system comprising a first dental appliance having a first geometry, a second dental appliance having a second geometry, and a third dental appliance having a third geometry, the system produced by a method comprising:
performing a lower arch stage of treatment planning to define movement, to be effected by the first geometry, of at least one tooth of a lower arch;
performing an upper arch stage of treatment planning to define movement, to be effected by the second geometry, of at least one tooth of an upper arch; and
performing a final arch stage of treatment planning to define articulation, to be effected by the third geometry, of the lower and upper arches,
wherein the upper arch stage of treatment planning involves fitting teeth of the upper arch to teeth of the lower arch, while using the lower arch as a reference.

28. A computer-readable storage medium storing a program which, when executed by a computer processor, causes the computer processor to effect an orthodontic treatment plan, the program comprising:
first code defining a lower arch stage of treatment planning for effecting movement of at least one tooth of a lower arch;
second code defining an upper arch stage of treatment planning for effecting movement of at least one tooth of an upper arch; and
third code defining on a final arch stage of treatment planning for effecting articulation of the lower and upper arches,
wherein the upper arch stage of treatment planning involves fitting teeth of the upper arch to teeth of the lower arch, while using the lower arch as a reference.

29. The computer-readable storage medium of claim 28, wherein at least one of the first code, the second code, or the third code represents a model of one of a dental appliance or at least one dental arch.

30. The computer-readable storage medium of claim 28, wherein dental appliances are manufactured based upon at least one of the first code, the second code, or the third code.
